(19) United States
(12) Patent Application Publication
(10) Pub. No.: US 2011/0110207 A1
(43) Pub. Date: May 12, 2011

(54) OPTICAL UNIT, CONTROL METHOD, AND OPTICAL INFORMATION RECORDING/REPRODUCING DEVICE

(76) Inventor: Ryuichi Katayama, Tokyo (JP)

(21) Appl. No.: 13/003,847

(22) PCT Filed: Jul. 9, 2009
(86) PCT No.: PCT/JP2009/062501

§ 371 Date: Jan. 12, 2011

(30) Foreign Application Priority Data
Jul. 28, 2008 (JP) 2008-193385

(51) Int. Cl. G11B 7/135; G11B 7/00

(52) U.S. Cl. 369/44.32; 369/112.24; 369/44.11; G9B/7.121; G9B/7

(57) ABSTRACT

An optical unit includes an optical system for shining a laser beam on an optical recording medium having a recording layer and a focus control reference surface. The optical system is composed of an objective lens for focusing a recording/reproducing beam emitting from a first light source in the recording layer and focusing a focus control beam emitted from a second light source on the focus control reference surface, a first lens system disposed along an optical path of the recording/reproducing beam and capable of discretely varying a focus position of the recording/reproducing beam in a direction of a thickness of the recording layer, and a second lens system disposed along an optical path common to the recording/reproducing beam and the focus control beam and capable of continuously varying focus positions of the recording/reproducing beam and the focus control beam in a direction of a thickness of the recording layer.

### TECHNICAL FIELD

The present invention relates to an optical unit and a control method for such, and more specifically relates to an optical unit for recording/reproducing information three-dimensionally on an optical recording medium, and a control method for such an optical unit. In addition, the present invention relates to an optical information recording/reproducing device equipped with the above-described optical unit.

### BACKGROUND ART

As one technology for increasing the capacity of optical recording media, a three-dimensional recording/reproducing technology has been known which records information three-dimensionally on an optical recording medium using the dimension in a direction of thickness in addition to the dimensions in the intra-surface directions of the optical recording medium. One three-dimensional recording/reproducing technology is a bit-type hologram recording technology. With bit-type hologram recording technology, information is recorded by causing two opposing beams to focus and interfere at the same position in the recording layer of the optical recording medium, forming a minute diffraction grating at the focus point. When reproducing information, one of the two beams is focused in the recording layer of the optical recording medium and detects light reflected from the diffraction grating to reproduce information.

In Non-Patent Literature 1, an optical unit for bit-type hologram recording is disclosed. FIG. 13 shows the optical unit disclosed in Non-Patent Literature 1. First, we will describe the operation when recording information. Light emitted from a semiconductor laser 53a, which is a recording/reproducing beam, is converted from divergent light into parallel light by passing through a convex lens 54a, a portion is transmitted by a beam splitter 55a and a portion is reflected by the beam splitter 55a. The light transmitted by the beam splitter 55a is reflected by an interference filter 56 and is incident on an objective lens 59a, and is then focused in the recording layer of a disc 52a by the objective lens 59a.

On the other hand, the light reflected by the beam splitter 55a traverses an open shutter 58 and a portion is reflected by a beam splitter 55b, is reflected by a mirror 57 and is incident on an objective lens 59b, and is focused in the recording layer of the disc 52 by the objective lens 59b. The light transmitted by the beam splitter 55a and the light reflected by the beam splitter 55a are focused and interfere at the same position in the recording layer of the disc 52, so that a minute diffraction grate is formed at the focus point.

A convex lens 54c and a light detector 60b detect deviations in the position of the focus spot of light emitted from the semiconductor laser 53a and reflected by the beam splitter 55a relative to the position of the focus spot of light emitted from the semiconductor laser 53a and transmitted by the beam splitter 55a. When recording information to the disc 52, the objective lens 59b controls the focus position of the beam focused in the recording layer so that positional deviation becomes 0. Through this control, the light transmitted by the beam splitter 55a and the light reflected by the beam splitter 55a can be focused at the same position in the recording layer.

Next, we will describe the operation when reproducing information. The shutter 58 is controlled to be closed when reproducing information. Light emitted from the semiconductor laser 53a is converted from divergent light into parallel light by passing through the convex lens 54a, and a portion is transmitted by the beam splitter 55a while a portion is reflected by the beam splitter 55a. To this point, the operation is the same as the operation when recording information. Because the shutter 58 is controlled to be closed when reproducing information, the light reflected by the beam splitter 55a is blocked by the shutter 58 and does not reach the disc 52. On the other hand, the light transmitted by the beam splitter 55a traverses the same route as when recording information and is focused in the recording layer of the disc 52.

The light focused in the recording layer on the disc 52 is reflected by the diffraction grating formed at the focus point, passes through the objective lens 59a in the opposite direction, is reflected by the interference filter 56 and a portion is reflected by the beam splitter 55a. The light reflected by the beam splitter 55a is incident on the convex lens 54b and is focused on a receiver of a light detector 60a by the convex lens 54b.

The diffraction grating formed in the disc 52 has bit data information. When recording information, the position of the focus spot of light emitted from the semiconductor laser 53a transmitted by the beam splitter 55a and light emitted from the semiconductor laser 53a reflected by the beam splitter 55a is moved in a direction of a thickness of the recording layer of the disc 52. By doing this, diffraction gratings are formed at multiple positions in a direction of a thickness in addition to the intra-surface direction of the recording layer on the disc 52, so information can be recorded in multiple layers in a direction of a thickness of the recording layer on the disc 52. In addition, when reproducing information, it is possible to reproduce information from the diffraction gratings recorded on multiple layers.

The semiconductor laser 53b emits a beam used in focus control. The light emitted from the semiconductor laser 53b (the focus control beam) is converted from divergent light into parallel light by passing through a convex lens 54d, and a portion of the light is transmitted by a beam splitter 55c. The light transmitted by the beam splitter 55c is transmitted by an interference filter 56 and is incident on an objective lens 59a, and is focused on a focus control reference surface of the disc 52 by the objective lens 59a. This light is reflected by the focus control reference surface, traverses the objective lens 59a in the opposite direction and is transmitted by the interference filter 56. A portion of the light transmitted by the interference filter 56 is reflected by the beam splitter 55c and is incident on an objective lens 54e, and is focused on a receiver of a light detector 60c by the objective lens 54e.

Based on output from the light detector 60c, a focus error signal is created that expresses deviation from the position of the focus spot of light emitted from the semiconductor laser 53b on the focus control reference surface. By driving the objective lens 59a so that this focus error signal becomes 0, it is possible to control the position of the focus spot of light emitted from the semiconductor laser 53a and transmitted by the beam splitter 55a in a direction of a thickness of the recording layer on the disc 52. In addition, by applying an electrical offset to the focus error signal and varying this offset, it is possible to vary the position of the focus spot of light emitted from the semiconductor laser 53a and transmitted by the beam splitter 55a in a direction of a thickness of the recording layer on the disc 52.

### Prior Art Literature

### Non-Patent Literature

Non-Patent Literature 1: “Drive System for Micro-Reflector Recording Employing Blue Laser Diode”, International Symposium on Optical Memory 2006 Technical Digest, pp. 36-37.

### Disclosure of Invention

### Problem Solved by the Invention

In the optical unit disclosed in Non-Patent Literature 1, when recording/reproducing information on multiple layers in a direction of a thickness of the recording layer on the disc 52, the objective lens 59a is driven so that the focus error signal created using the focus control beam becomes 0. By driving the objective lens, the position of the focus spot of the recording/reproducing beam in a direction of a thickness of the recording layer on the disc 52 is controlled, and the focus spot of the recording/reproducing beam can be positioned at a specific layer. In addition, by varying the electrical offset given to the focus error signal, the position of the focus spot of the recording/reproducing beam can be varied in a direction of a thickness of the recording layer on the disc 52, switching the position (layer) where the recording/reproducing beam is focused.

Aberrations in an optical unit differ depending on the optical unit because of variances in the components and variance in assembly of the optical unit. Consequently, the sensitivity of the focus error signal differs for each optical unit, and the relationship between the electrical offset given to the focus error signal and the position of the focus spot of the recording/reproducing beam differs for each optical unit. Accordingly, with the optical unit according to Non-Patent Literature 1, the position of the focus spot of the recording/reproducing beam deviates in a direction of a thickness of the recording layer on the disc 52 from the position of the layer where recording/reproducing should be accomplished, making it impossible to correctly position the focus spot of the recording/reproducing beam on the layer where recording/reproducing should be accomplished. As a result, the information recorded on the disc 52 using an optical unit cannot be correctly reproduced from the disc 52 using a different optical unit. In other words, it is impossible to ensure compatibility of the disc 52 among multiple optical units and optical information recording/reproducing devices.

It is an objective of the present invention to provide an optical unit that can correctly position the focus spot of the recording/reproducing beam on the layer where recording/reproducing should be accomplished, and a control method for such.

### Means for Solving the Problem

A first aspect of the present invention provides an optical unit including an optical system for shining a laser light on an optical recording medium having a recording layer and a focus control reference surface, this optical system having an objective lens for focusing a recording/reproducing beam emitted from a first light source in the recording layer and focusing a focus control beam emitted from a second light source on the focus control reference surface, a first lens system disposed along an optical path of the recording/reproducing beam and capable of discretely varying a focus position of the recording/reproducing beam in a direction of a thickness of the recording layer, and a second lens system disposed along an optical path common to the recording/reproducing beam and the focus control beam and capable of continuously varying focus positions of the recording/reproducing beam and the focus control beam in a direction of a thickness of the recording layer.

A second aspect of the present invention provides an optical information recording/reproducing device having the above-described optical unit according to the present invention, a first focus position varying circuit for driving the first lens system and varying a focus position of the recording/reproducing beam, an error signal generating circuit for generating a focus error signal for controlling focus positions of the recording/reproducing beam and the focus control beam in a direction of a thickness of the recording layer on the basis of an output from a light detector that receives a light of the focus control beam reflected from the optical recording medium, and a second focus position varying circuit for driving the second lens system on the basis of the focus error signal and varying focus positions of the recording/reproducing beam and the focus control beam.

A third aspect of the present invention provides an optical information recording/reproducing device having an optical unit according to the present invention, a first focus position varying circuit for driving the first lens system and varying a focus position of the recording/reproducing beam, an error signal generating circuit for generating a focus error signal for controlling focus positions of the recording/reproducing beam and the focus control beam in a direction of a thickness of the recording layer on the basis of an output from a light detector that receives a light of the focus control beam reflected from the optical recording medium, a second focus position varying circuit for driving the second lens system on the basis of the focus error signal and varying focus positions of the recording/reproducing beam and the focus control beam, and a beam switching unit driver circuit for driving the beam switching unit and making the recording/reproducing beam the two beams when recording information on the optical recording medium and making the recording/reproducing beam the single beam when reproducing information from the optical recording medium.

A fourth aspect of the present invention provides an optical unit control method, being an optical unit control method for shining a laser light on an optical recording medium having a recording layer and a focus control reference surface, this method shining a recording/reproducing beam from a first light source on an optical recording medium, shining a focus control beam from a second light source on an optical recording medium, continuously controlling a focus position of the focus control beam in a direction of a thickness of the recording layer and focusing the focus control beam on the focus control reference surface, and discretely varying a focus position of the recording/reproducing beam in a direction of a thickness of the recording layer.

### Efficacy of the Invention

The optical unit, control method and optical information recording/reproducing device according to the present invention can correctly position the focus spot of the recording/reproducing beam on the layer where recording/reproducing should be accomplished.

A more complete understanding of the above and other objectives, characteristics and benefits of the present invention can be obtained when the following detailed description is considered in conjunction with the following drawings.

### BRIEF DESCRIPTION OF DRAWINGS

FIG. 1 is a block diagram showing an optical unit according to a first embodiment of the present invention.

FIGS. 2A-2C show the beam incident on the disc and the beam reflected from the disc when recording information.

FIGS. 3A-3C show the beam incident on the disc and the beam reflected from the disc when reproducing information.

FIG. 4 is a cross-sectional view showing the composition of the active diffraction lens.

FIG. 5 is a table showing the relationship between the voltage impressed on the liquid crystal layer and the focal length of the active diffraction lens.

FIGS. 6A-6C show the variable focus lens.

FIG. 7 is a block diagram showing an optical information recording/reproducing device equipped with the optical unit shown in FIG. 1.

FIG. 8 is a block diagram showing an optical unit according to a second embodiment of the present invention.

FIGS. 9A-9C show the beam incident on the disc and the beam reflected from the disc when recording information.

FIGS. 10A-10C show the beam incident on the disc and the beam reflected from the disc when reproducing information.

FIGS. 11A-11C show the variable focus lens used in the optical unit shown in FIG. 8.

FIG. 12 is a block diagram showing an optical information recording/reproducing device equipped with the optical unit shown in FIG. 8.

FIG. 13 is a block diagram showing an optical unit disclosed in Non-Patent Literature 1.

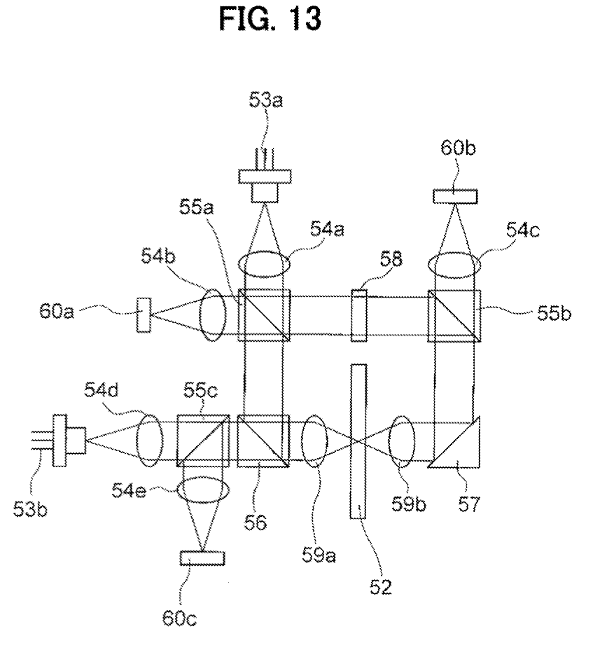

### BEST MODE FOR CARRYING OUT THE INVENTION

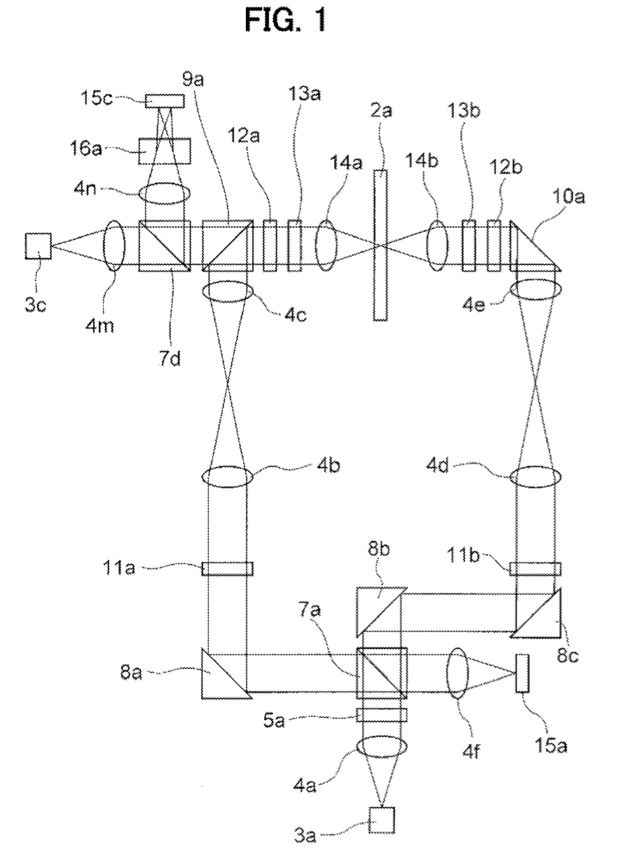

The preferred embodiments of the present invention are described in detail below with reference to the drawings. FIG. 1 shows an optical unit according to a first embodiment of the present invention. The optical unit is provided with lasers 3a and 3c, and an optical system to guide light emitted from the lasers to an optical recording medium (disc) 2a. The optical system includes convex lenses 4a-4f, 4m and 4n, an active wavelength plate 5a, polarizing beam splitters 7a and 7d, mirrors 8a to 8c, an interference filter 9a, a mirror 10a, active diffraction lenses 11a and 11b, variable focus lenses 12a and 12b, quarter-wave plates 13a and 13b, objective lenses 14a and 14b, light detectors 15a and 15c, and a cylindrical lens 16a. The disc 2a is a medium on which the optical unit records and reproduces data, and has a recording layer and a focus control reference surface.

The laser 3a is a semiconductor laser and is a first light source that emits a recording/reproducing beam. The laser 3c is a semiconductor laser and is a second light source that emits a focus control beam. The laser 3a emits a recording/reproducing beam with a wavelength of 405 nm. The laser 3c emits a focus control beam with a wavelength of 650 nm. The optical unit records information on the disc 2a and reproduces information from the disc 2a using the recording/reproducing beam emitted from the laser 3a.

The active wave plate 5a can switch between having the function of a quarter-wave plate and having the function of a half-wave plate. The polarizing beam splitters 7a and 7d transmit light with a predetermined polarization direction and reflect light with other polarization directions. Light emitted from the active wave plate 5a is incident on the polarizing beam splitter 7a. When the active wave plate 5a has the function of a quarter-wave plate, the polarizing beam splitter 7a transmits around 50% of incident light and reflects the remaining 50%. In addition, when the active wave plate 5a has the function of a half-wave plate, the polarizing beam splitter 7a reflects virtually 100% of the incident light. The active wave plate 5a and the polarizing beam splitter 7a correspond to a beam switching device that switches between making the recording/reproducing beam two beams that are focused on the same position from mutually opposite directions in the recording layer of the disc 2a, and making the recording/reproducing beam a single beam.

The active wave plate 5a is composed of a liquid crystal layer interposed between two substrates. On the surfaces of the two substrates on the liquid crystal layer side, transparent electrodes are formed for impressing alternating voltages on the liquid crystal layer. The liquid crystal layer has a single axis of refractive anisotropy. When an alternating voltage with an effective value of 2.5 V is impressed on the liquid crystal layer, the direction of the optical axis of the liquid crystal layer becomes a direction midway between a direction orthogonal to and a direction parallel to the optical axis of the incident light. At this time, the phase difference created in the light passing through the liquid crystal layer between the component polarized in a direction parallel to the surface containing the optical axis and the light axis and the component polarized in an orthogonal direction is π/2 and the active wave plate 5a has the function of a quarter-wave plate. On the other hand, when an alternating voltage is not impressed on the liquid crystal layer, the direction of the optical axis of the liquid crystal layer is a direction orthogonal to the optical axis of the incident light. At this time, the phase difference created in the light passing through the liquid crystal layer between the component polarized in a direction parallel to the surface containing the optical axis and the light axis and the component polarized in an orthogonal direction is π and the active wave plate 5a has the function of a half-wave plate.

The interference filter 9a reflects light with a 405 nm wavelength used as the recording/reproducing beam, and transmits light with a 650 nm wavelength used as the focus control beam. The optical path from the interference filter 9a to the disc 2a is a common optical path for both the recording/reproducing beam and the focus control beam. The objective lens 14a focuses the recording/reproducing beam in the recording layer of the disc 2a and focuses the focus control beam on the focus control reference surface. In addition, the objective lens 14b focuses the recording/reproducing beam in the recording layer of the disc 2a from the surface on the opposite side from the objective lens 14a. The light detector (first light detector) 15a receives the light of the recording/reproducing beam reflected from the disc 2a. The light detector (second detector) 15c receives the light of the focus control beam reflected from the disc 2a.

The active diffraction lenses 11a and 11b discretely vary the focus position of the recording/reproducing beams focused by the objective lenses 14a and 14b, respectively, in a direction of a thickness of the recording layer. The active diffraction lenses 11a and 11b are diffractive lenses capable of discretely varying focal length in accordance with an impressed voltage, and selectively creating one out of multiple diffraction beams of mutually differing degrees from the incident beam. The active diffraction lenses 11a and 11b are positioned in the optical path of the recording/reproducing beam and correspond to a first lens system capable of discretely varying the focus position of the recording/reproducing beam in the disc 2a in a direction of a thickness of the recording layer.

The variable focus lenses 12a and 12b continuously vary the focus position of the beams focused by the objective lenses 14a and 14b, respectively. The variable focus lens 12a is positioned in the optical path common to the recording/reproducing beam and the focus control beam. On the other hand, the variable focus lens 12b is positioned in the optical path of recording/reproducing beam. The focal lengths of the variable focus lenses 12a and 12b continuously vary in accordance with the impressed voltage. The variable focus lens 12a corresponds to a second lens system capable of continuously varying the focus positions of the recording/reproducing beam and the focus control beam in a direction of a thickness of the recording layer on the disc 2a.

The beam (recording/reproducing beam) emitted from the laser 3a is transmitted by the convex lens 4a and converted from divergent light to parallel light, and is incident on the active wave plate 5a. The active wave plate 5a is controlled so as to have the function of a quarter-wave plate with respect to the incident light when recording information on the disc 2a. In addition, the active wave plate 5a is controlled so as to have the function of a half-wave plate with respect to the incident light when reproducing information from the disc 2a.

When recording information on the disc 2a, the beam incident on the active wave plate 5a is converted to circularly polarized light from linearly polarized light by passing through the active wave plate 5a having the function of a quarter-wave plate. Approximately 50% of this converted light is reflected by the polarizing beam splitter 7a as an S-polarized light component and the remaining 50% is transmitted by the polarizing beam splitter 7a as a P-polarized light component. On the other hand, when reproducing information from the disc 2a the beam reflected by the active wave plate 5a is transmitted by the active wave plate 5a having the function of a half-wave plate, the polarization direction is changed 90°, and the beam is then incident on the polarizing beam splitter 7a as the S-polarized light component and is virtually 100% reflected.

When recording information on the disc 2a, the beam reflected by the polarizing beam splitter 7a is reflected by the mirror 8a, is diffracted by the active diffraction lens 11a and passes through the relay lens system composed of the convex lenses 4b and 4c without receiving the action as a lens. The beam transmitted by the convex lenses 4b and 4c is reflected by the interference filter 9a, is transmitted by the variable focus lens 12a, is transmitted by the quarter-wave plate 13a and converted from linearly polarized light into circularly polarized light, and is focused in the disc 2a by the objective lens 14a.

In addition, the beam transmitted by the polarizing beam splitter 7a is reflected by the mirrors 8b and 8c, is diffracted by the active diffraction lens 11b and passes through the relay lens system composed of the convex lenses 4d and 4e without receiving the action as a lens. The light transmitted by the convex lenses 4d and 4e is reflected by the minor 10a, is transmitted by the variable focus lens 12b, is transmitted by the quarter-wave plate 13b and is converted from linearly polarized light into circularly polarized light, and is focused in the disc 2a by the objective lens 14b. When recording information, the beam transmitted by the polarizing beam splitter 7a and the beam reflected by the polarizing beam splitter 7a are focused on the same position in mutually opposing directions in the recording layer of the disc 2a.

On the other hand, when reproducing information from the disc 2a, the beam reflected by the polarizing beam splitter 7a is reflected by the mirror 8a, is diffracted by the active diffraction lens 11a and passes through the relay lens system composed of the convex lenses 4b and 4c without receiving the action as a lens. The beam transmitted by the convex lenses 4b and 4c is reflected by the interference filter 9a, is transmitted by the variable focus lens 12a, is transmitted by the quarter-wave plate 13a and is converted from linearly polarized light into circularly polarized light, and is focused in the recording layer of the disc 2a by the objective lens 14a.

The beam focused in the recording layer of the disc 2a is reflected by diffraction gratings formed in the disc 2a. This reflected beam traverses the objective lens 14a in the opposite direction, is transmitted by the quarter-wave plate 13a and is converted from circularly polarized light into linearly polarized light, is transmitted by the variable focus lens 12a and is reflected by the interference filter 9a. The beam reflected by the interference filter 9a passes through the relay lens system composed of the convex lenses 4c and 4b without receiving the action as a lens, is diffracted by the active diffraction lens 11a, is reflected by the mirror 8a and is incident on the polarizing beam splitter 7a as P-polarized light. The beam incident on the polarizing beam splitter 7a is virtually 100% transmitted, is transmitted by the convex lens 4f and converted into convergent light from parallel light, and is received by the light detector 15a. The reproduction signal that is information recorded on the disc 2a is generated on the basis of the output from the light detector 15a.

When recording information or reproducing information, the beam emitted from the laser 3c, which is the second light source, is transmitted by a convex lens 4m and converted from divergent light into weakly convergent light, is incident on the polarizing beam splitter 7d as P-polarized light and virtually 100% transmitted, and is transmitted by the interference filter 9a. The beam transmitted by the interference filter 9a is transmitted by the variable focus lens 12a, is transmitted by the quarter-wave plate 13a and converted from linearly polarized light into circularly polarized light, and is focused on the focus control reference surface in the disc 2a by the objective lens 14a.

The beam reflected by the disc 2a traverses the objective lens 14a in the opposite direction, is transmitted by the quarter-wave plate 13a and converted from circularly polarized light into linearly polarized light, is transmitted by the variable focus lens 12a and is transmitted by the interference filter 9a. The beam transmitted by the interference filter 9a is incident on the polarizing beam splitter 7d as S-polarized light and is virtually 100% reflected, is transmitted by the convex lens 4n and converted from weakly divergent light into convergent light, is given astigmatism by the cylindrical lens 16a and is detected by the light detector 15c. A focus error signal is generated on the basis of the output from the light detector 15c in order to control the focus positions of the recording/reproducing beam and the focus control beam in a direction of a thickness of the recording layer on the disc 2a. A commonly known astigmatism method can be used in generating the focus error signal.

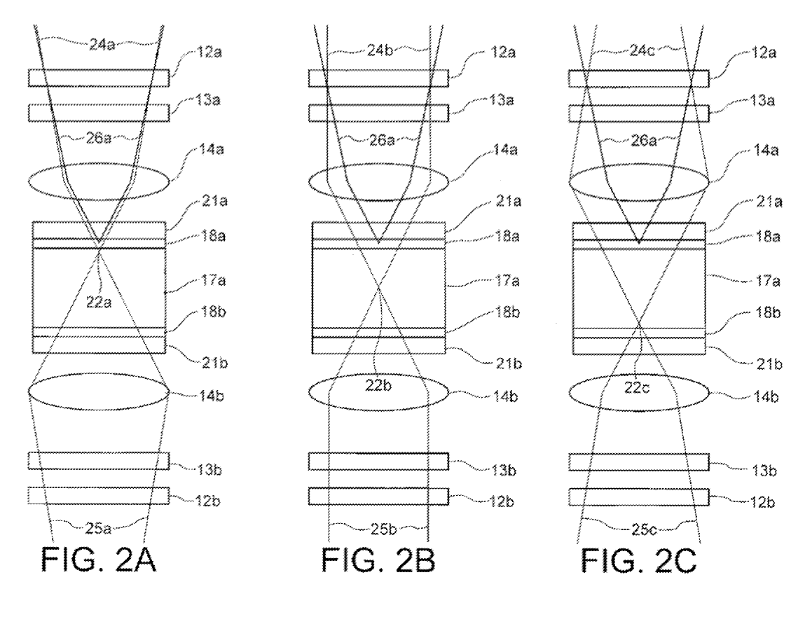

FIGS. 2A-2C show the beams incident on the disc 2a and the beams reflected from the disc 2a when recording information on the disc 2a. The disc 2a has a composition with the recording layer 17a interposed between substrates 21a and 21b. The surface of the substrates 21a and 21b on the recording layer 17a side is formed by wavelength selection layers 18a and 18b, respectively. These wavelength selection layers 18a and 18b transmit beams of 405 nm wavelength and reflect beams of 650 nm wavelength. The wavelength selection layer 18a corresponds to the focus control reference surface. Glass, for example, may be used as the material of the substrates 21a and 21b. A photopolymer, for example, may be used as the material for the recording layer 17a. Silicon dioxide or titanium dioxide, for example, may be used as the material for the wavelength selection layers 18a and 18b.

The beams 24 (24a to 24c) and 25 (25a to 25c) in FIGS. 2A to 2C are recording/reproducing beams. The beams 24a to 24c are beams that are selectively generated by the active diffraction lens 11a from a beam emitted from the laser 3a (FIG. 1) and reflected by the polarizing beam splitter 7a, when recording information on the disc 2a. In addition, the beams 25a to 25c are beams selectively generated by the active diffraction lens 11b from a beam emitted from the laser 3a and transmitted by the polarizing beam splitter 7a when recording information on the disc 2a. The beam 26a is a focus control beam.

FIG. 2A shows the state when the beams 24a and 25a are focused on a focus point 22a that is a position near the substrate 21a within the recording layer 17a. When the focus point is at the position shown in FIG. 2A, the active diffraction lens 11a acts as a convex lens on the beam 24a. The beam 24a is incident on the objective lens 14a as weakly convergent light. On the other hand, the active diffraction lens 11b acts as a concave lens on the beam 25a. The beam 25a is incident on the objective lens 14b as weakly divergent light. The beam 24a and the beam 25a interfere at the focus point 22a so that a minute diffraction grating is formed at the focus point 22a.

FIG. 2B shows the state when the beams 24b and 25b are focused on a focus point 22b at a position midway between the substrates 21a and 21b in the recording layer 17a. When the focus point is at the position shown in FIG. 2B, the active diffraction lens 11a does not act as a lens on the beam 24b. In addition, the active diffraction lens 11b does not act as a lens on the beam 25b. The beam 24b and the beam 25b are incident on the objective lenses 14a and 14b, respectively, as parallel light. The beam 24b and the beam 25b interfere at the focus point 22b so that a minute diffraction grating is formed at the focus point 22b.

FIG. 2C shows the state when the beams 24c and 25c are focused at a focus point in a position near the substrate 21b within the recording layer 17a. When the focus point is at the position shown in FIG. 2C, the active diffraction lens 11a acts as a concave lens on the beam 24c. The beam 24c is incident on the objective lens 14a as weakly divergent light. On the other hand, the active diffraction lens 11b acts as a convex lens on the beam 25c. The beam 25c is incident on the objective lens 14b as weakly convergent light. The beam 24c and the beam 25c interfere at the focus point 22c so that a minute diffraction grating is formed at the focus point 22c.

On the other hand, the beam 26a that is the focus control beam is focused on the wavelength selection layer 18a with no dependence on the focus position of the recording/reproducing beam, as shown in FIGS. 2A to 2C. The focus control beam 26a emitted from the laser 3c when recording information on the disc is incident on the objective lens 14a as weakly convergent light, and is focused on the wavelength selection layer 18a. The beam 26a focused on the wavelength selection layer 18a is reflected by the wavelength selection layer 18a and is emitted from the objective lens 14a as weakly divergent light. This reflected beam is ultimately received by the light detector 15c of FIG. 1.

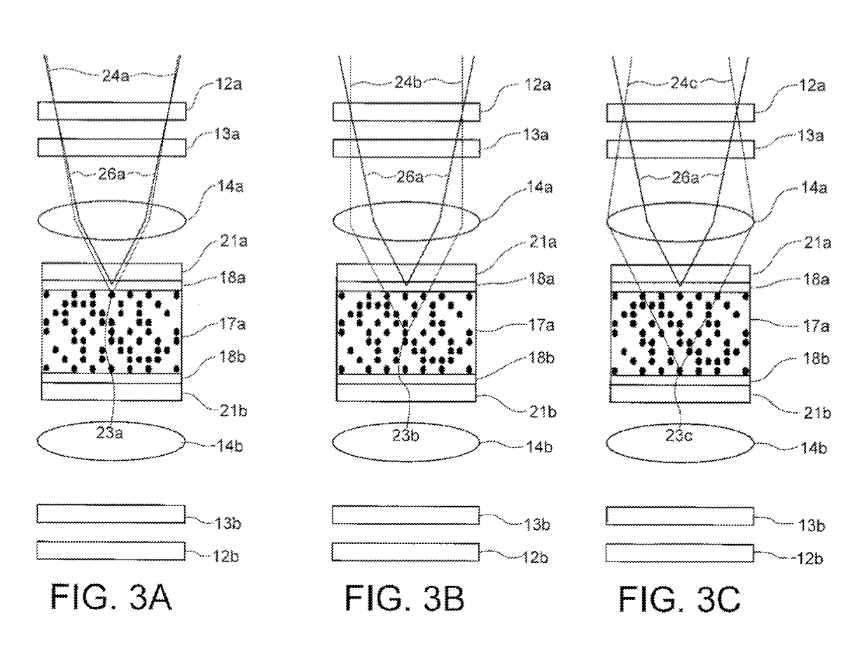

FIGS. 3A to 3C show the beam incident on the disc 2a and the beam reflected from the disc 2a when reproducing information from the disc 2a. A diffraction grating having bit data information is formed in the recording layer 17a of the disc 2a. The beam 24 (24a to 24c) in FIGS. 3A to 3C is a recording/reproducing beam. The beams 24a to 24c are beams selectively generated by the active diffraction lens 11a from a beam emitted from the laser 3a and reflected by the polarizing beam splitter 7a when reproducing information from the disc 2a. The beam 26a is the focus control beam.

FIG. 3A shows the state when the beam 24a is focused on a diffraction grating 23a at a position near the substrate 21a in the recording layer 17a. The diffraction grating 23a is formed at the position of the focus point 22a in FIG. 2A. When information is read out from the diffraction grating 23a, the active diffraction lens 11a acts as a convex lens on the beam 24a. The beam 24a is incident on the objective lens 14a as weakly convergent light. The beam 24a focused at the diffraction grating 23a is reflected by the diffraction grating 23a and is emitted from the objective lens 14a as weakly divergent light. This reflected beam is ultimately received by the light detector 15a of FIG. 1.

FIG. 3B shows the state when the beam 24b is focused on a diffraction grating 23b at a position midway between the substrates 21a and 21b in the recording layer 17a. The diffraction grating 23b is formed at the position of the focus point 22b in FIG. 2B. When information is read out from the diffraction grating 23b, the active diffraction lens 11a does not act as a lens on the beam 24b. The beam 24b is incident on the objective lens 14a as parallel light. The beam 24b focused at the diffraction grating 23b is reflected by the diffraction grating 23b and is emitted from the objective lens 14a as parallel light. This reflected beam is ultimately received by the light detector 15a.

FIG. 3C shows the state when the beam 24a is focused on a diffraction grating 23c at a position near the substrate 21b in the recording layer 17a. The diffraction grating 23c is formed at the position of the focus point 22c in FIG. 2C. When information is read out from the diffraction grating 23c, the active diffraction lens 11a acts as a concave lens on the beam 24c. The beam 24c is incident on the objective lens 14a as weakly divergent light. The beam 24c focused at the diffraction grating 23c is reflected by the diffraction grating 23c and is emitted from the objective lens 14a as weakly convergent light. This reflected beam is ultimately received by the light detector 15a.

On the other hand, the focus control beam 26a is focused on the wavelength selection layer 18a with no dependence on the focus position of the recording/reproducing beam, as snow in FIGS. 3A to 3C. The focus control beam 26a emitted from the laser 3c (see FIG. 1) when reproducing information on the disc is incident on the objective lens 14a as weakly convergent light and is focused on the wavelength selection layer 18a. The beam 26a focused on the wavelength selection layer 18a is reflected by the wavelength selection layer 18a and is emitted from the objective lens 14a as weakly divergent light. This reflected beam is ultimately received by the light detector 15c of FIG. 1.

The active diffraction lenses 11a and 11b selectively generate one of the multiple beams in accordance with the number of recording positions in a direction of a thickness in the recording layer 17a. If, for example, recording/reproducing information is possible at nine locations (nine layers) in a direction of a thickness of the recording layer 17a, the active diffraction lens 11a selectively generates one of the nine beams containing beams 24a to 24c (FIGS. 2A to 2C, FIGS. 3A to 3C). In addition, the active diffraction lens 11b selectively generates one out of the nine beams containing beams 25a to 25c (FIGS. 2A to 2C). The active diffraction lenses 11a and 11b selectively generate one out of the nine beams, respectively, and discretely vary the distance between the focus point of the beam 26a and the focus point of the selectively generated beam in nine steps. Through this discrete variation, the position of the focus point of the selectively generated beam can be varied discretely in nine steps in a direction of a thickness of the recording layer 17a. That is to say, using the selectively generated beam it is possible to record/reproduce information in nine layers in a direction of a thickness of the recording layer 17a.

The variable focus lens 12a disposed along the common optical path controls the beams 24a to 24c that are recording/reproducing beams and the focus position of the beam 26a that is the focus control beam. When the variable focus lens 12a is controlled and the focus position of the focus control beam 26a is varied, the focus position of the recording/reproducing beams 24a to 24c also varies accompanying that. At this time, the distance between the beams 24a to 24c and the beam 26a is determined in accordance with the beam selected by the active diffraction lens 11a. Consequently, even when the focus position of the focus control beam 26a is varied, the distance between the beams 24a to 24c and the beam 26a does not vary. Accordingly, using the variable focus lens 12a, the position of the focus point of the beam 26a is controlled so that the focus error signal becomes 0 and the beam 26a is focused on the wavelength selection layer 18a. Through this focus position control, it is possible to accurately focus the beams 24a to 24c at a position separated from the wavelength selection layer 18a by a distance in accordance with the beam selected by the active diffraction lens 11a.

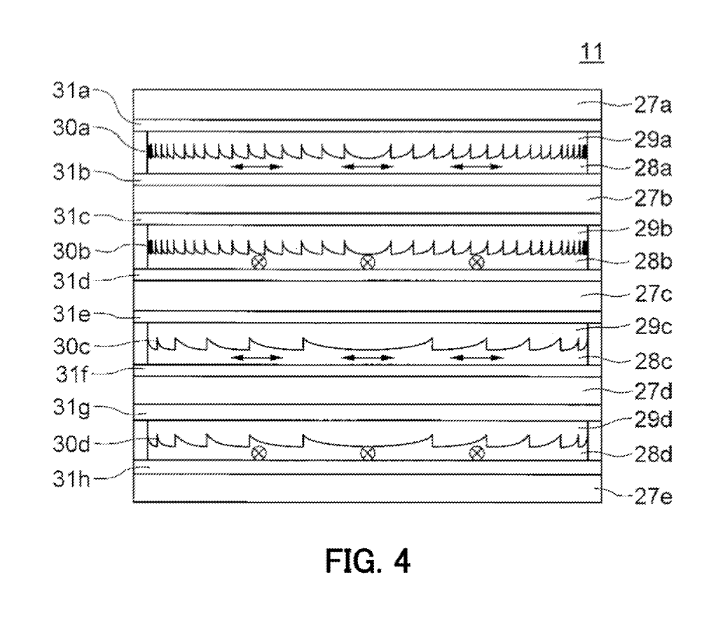

FIG. 4 shows a cross section of the active diffraction lenses 11a and 11b. Here, the active diffraction lenses 11a and 11b are explained as an active diffraction lens 11. The active diffraction lens 11 has a composition in which a liquid crystal layer 28a and a filler 29a are interposed between substrates 27a and 27b, a liquid crystal layer 28b and a filler 29b are interposed between substrates 27b and 27c, a liquid crystal layer 28c and a filler 29c are interposed between substrates 27c and 27d, and a liquid crystal layer 28d and a filler 29d are interposed between substrates 27d and 27e. Fresnel-type diffraction lenses 30a to 30d are formed at the boundary surfaces between the mutually opposing liquid crystal layers 28a to 28d and fillers 29a to 29d.

In addition, transparent electrodes 31a and 31b for impressing alternating voltages on the liquid crystal layer 28a are formed on the surfaces of the substrates 27a and 27b toward the liquid crystal layer 28a. Transparent electrodes 31c and 31d for impressing alternating voltages on the liquid crystal layer 28b are formed on the surfaces of the substrates 27b and 27c toward the liquid crystal layer 28b. Transparent electrodes 31e and 31f for impressing alternating voltages on the liquid crystal layer 28c are formed on the surfaces of the substrates 27c and 27d toward the liquid crystal layer 28c. Transparent electrodes 31g and 31h for impressing alternating voltages on the liquid crystal layer 28d are formed on the surfaces of the substrates 27d and 27e toward the liquid crystal layer 28d.

Glass, for example, is used in the material of the substrates 27a to 27e. A nematic liquid crystal, for example, is used in the material of the liquid crystal layers 28a to 28d. Silicon oxynitride, for example, is used in the material of the fillers 29a to 29d. ITO (indium tin oxide), for example, is used in the material of the transparent electrodes 31a to 31h.

The active diffraction lens 11 has multiple diffraction lenses in which the focal length can be varied discretely. In the composition of FIG. 4, the active diffraction lens 11 has diffraction lenses 30a and 30b comprising a first diffraction lens and diffraction lenses 30c and 30d comprising a second diffraction lens. The diffraction lens 30a and the diffraction lens 30b comprising the first diffraction lens have mutually identical variation amounts in focal length, and the diffraction lens 30c and the diffraction lens 30d comprising the second diffraction lens have mutually identical variation amounts in focal length. In addition, the diffraction lenses 30a and 30b have mutually differing variation amounts in focal length from the diffraction lenses 30c and 30d.

The diffraction lens 30a acts on first linearly polarized light whose direction of polarization is a first direction. In addition, the diffraction lens 30b acts on second linearly polarized light whose direction of polarization is a second direction orthogonal to the first direction. Because the first linearly polarized light or the second linearly polarized light is incident on the active diffraction lens 11, one out of the two diffraction lenses 30a and 30b comprising the first diffraction lens acts on the incident light.

The diffraction lens 30c acts on first linearly polarized light whose direction of polarization is the first direction. In addition, the diffraction lens 30d acts on second linearly polarized light whose direction of polarization is the second direction orthogonal to the first direction. Similar to the above, one out of the two diffraction lenses 30c and 30d comprising the second diffraction lens acts on the incident light.

The liquid crystal layers 28a to 28d have a single axis of refractive anisotropy. Calling n_{θ} the refractive index of the liquid crystal layers 28a to 28d in a direction parallel to the optical axis, nₒ the refractive index of the polarized light components in a direction orthogonal to the optical axis and n_{f} the refractive index of the fillers 29a to 29d, then n_{f}=(n_{θ}+nₒ)/2. When λ is the wavelength of the incident light, p is the lattice pitch of the diffraction lenses 30a to 30d, r is the distance from the optical axis and t is the thickness, then p=fλ/r and t=2λ/(n_{θ}−nₒ). However, the focal length f of the diffraction lenses 30a and 30d and the focal length f of the diffraction lenses 30c and 30d are different.

When n₁ is the refractive index of the liquid crystal layers 28a to 28d with respect to the incident light, and φ is the phase depth of the diffraction lenses 30a and 30d, then φ=2πt(n₁f−n₁)/λ. If φ=−2π, the −1 order refractive index becomes 1 and the diffraction lenses 30a to 30d operate as concave lenses with a focal length of −f. If φ=0, the transmissivity (0-dimension light efficiency) becomes 1 and the diffraction lenses 30a to 30d do not act as lenses. If φ=+2π, the +1 order refractive index becomes 1 and the diffraction lenses 30a to 30d act as convex lenses with a focal length of +f.

The optical axis of the liquid crystal layers 28a and 28c lies in a plane parallel to the plane of the paper including the optical axis of the incident light, and the optical axis of the liquid crystal layers 28b and 28d lies in a plane orthogonal to the plane of the paper including the optical axis of the incident light. The diffraction lenses 30a and 30c act on beams whose polarization direction is parallel to the plane of the paper but do not act on beams whose polarization direction is orthogonal to the plane of the paper. On the other hand, the diffraction lenses 30b and 30d act on beams whose polarization direction is orthogonal to the plane of the paper but do not act on beams whose polarization direction is parallel to the plane of the paper. Here, when recording information on the disc 2a, in FIG. 1 the polarization direction of the beam emitted from the laser 3a and reflected by the polarizing beam splitter 7a is orthogonal to plane of the paper in FIG. 4, and the polarization direction of the beam emitted from the laser 3a and transmitted by the polarizing beam splitter 7a is parallel to the plane of the paper. In addition, when reproducing information from the disc 2a, the polarization direction of the beam emitted from the laser 3a and reflected by the polarizing beam splitter 7a is orthogonal to plane of the paper and the polarization direction of the beam reflected by the disc 2a and transmitted by the polarizing beam splitter 7a is parallel to the plane of the paper.

When an alternating voltage is not impressed on the liquid crystal layers 28a to 28d, the optical axis of the liquid crystal layers 28a and 28c is parallel to the plane of the paper and orthogonal to the optical axis of the incident light. In addition, the optical axis of the liquid crystal layers 28b and 28d is orthogonal to the plane of the paper and orthogonal to the optical axis of the incident light. At this time, the refractive index of the liquid crystal layers 28a and 28c on beams with polarization direction parallel to the plane of the paper becomes n₁=n_{θ,} so the phase depth of the diffractive lenses 30a and 30c becomes φ=−2/π. In addition, the refractive index of the liquid crystal layers 28b and 28d on beams with polarization direction orthogonal to the plane of the paper becomes n₁=n_{θ}, so the phase depth of the diffractive lenses 30b and 30d becomes φ=−2π. Accordingly, the diffraction lenses 30a and 30c act as concave lenses with a focal length of −f on beams with polarization direction parallel to the plane of the paper, and the diffraction lenses 30b and 30d act as concave lenses with a focal length of −f on beams with polarization direction orthogonal to the plane of the paper.

When an alternating voltage with an effective value of 2.5 V is impressed on the liquid crystal layers, the optical axis of the liquid crystal layers 28a and 28c is parallel to the plane of the paper in a direction midway between the direction orthogonal to the optical axis of the incident light and the direction parallel to the optical axis of the incident light. In addition, when an alternating voltage with an effective value of 2.5 V is impressed on the liquid crystal layers, the optical axis of the liquid crystal layers 28b and 28d is orthogonal to the plane of the paper in a direction midway between the direction orthogonal to the optical axis of the incident light and the direction parallel to the optical axis of the incident light. At this time, taking the refractive index of the liquid crystal layers 28a and 28c on beams with polarization direction parallel to the plane of the paper to be n₁=(n_{θ}+nₒ)/2, the phase depth of the diffractive lenses 30a and 30c becomes φ=0. In addition, taking the refractive index of the liquid crystal layers 28b and 28d on beams with polarization direction orthogonal to the plane of the paper to be n₁=(n_{θ}+nₒ)/2, the phase depth of the diffractive lenses 30b and 30d becomes φ=0. Accordingly, the diffraction lenses 30a and 30c do not act as lenses on beams with polarization direction parallel to the plane of the paper, and the diffraction lenses 30b and 30d do not act as lenses on beams with polarization direction orthogonal to the plane of the paper.

When an alternating voltage with an effective value of 5 V is impressed on the liquid crystal layers, the optical axis of the liquid crystal layers 28a and 28c is parallel to the optical axis of the incident light and the optical axis of the liquid crystal layers 28b and 28d is parallel to the optical axis of the incident light. At this time, the refractive index of the liquid crystal layers 28a and 28c on beams with polarization direction parallel to the plane of the paper becomes n₁=nₒ, so the phase depth of the diffractive lenses 30a and 30c becomes φ=+2π. In addition, the refractive index of the liquid crystal layers 28b and 28d on beams with polarization direction orthogonal to the plane of the paper becomes n₁=nₒ, so the phase depth of the diffractive lenses 30b and 30d becomes φ=+2π. Accordingly, the diffraction lenses 30a and 30c act as convex lenses with a focal length of +f on beams with polarization direction parallel to the plane of the paper, and the diffraction lenses 30b and 30d act as convex lenses with a focal length of +f on beams with polarization direction orthogonal to the plane of the paper.

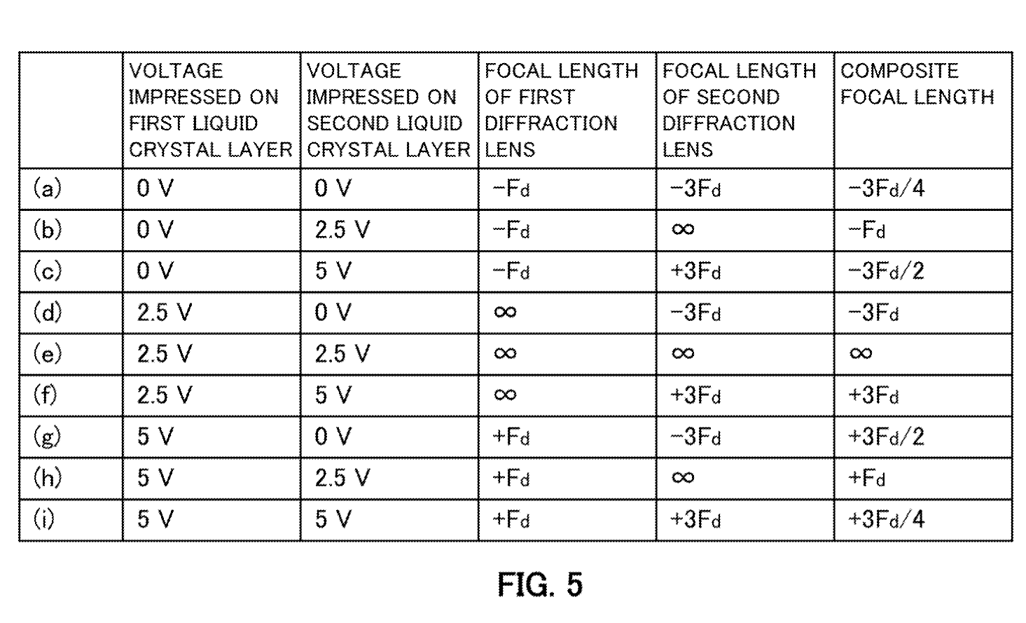

FIG. 5 shows the relationship between the voltage impressed on the liquid crystal layers in the active diffraction lens 11 and the focal length of the diffraction lens. The first liquid crystal layer in FIG. 5 indicates the liquid crystal layer 28a with respect to beams with polarization direction parallel to the plane of the paper and the liquid crystal layer 28b with respect to beams with polarization direction orthogonal to the plane of the paper. In addition, the second liquid crystal layer indicates the liquid crystal layer 28c with respect to beams with polarization direction parallel to the plane of the paper and the liquid crystal layer 28d with respect to beams with polarization direction orthogonal to the plane of the paper. The first diffraction lens indicates the diffraction lens 30a with respect to beams with polarization direction parallel to the plane of the paper and the diffraction lens 30b with respect to beams with polarization direction orthogonal to the plane of the paper. The second diffraction lens indicates the diffraction lens 30c with respect to beams with polarization direction parallel to the plane of the paper and the diffraction lens 30d with respect to beams with polarization direction orthogonal to the plane of the paper.

The first and second diffraction lenses selectively generate one out of −1 order refractive light, 0 order refractive light and +1 order refractive light from the incident light in accordance with the voltage impressed on the first and second liquid crystal layers, respectively. The f in the first diffraction lens is F_{d}, and the f in the second diffraction lens is 3F_{d}. Taking f_{d1} to be the focal length of the first diffraction lens, f_{d1} varies in three steps between −F_{d}, ∞, +3F_{d} in accordance with the voltage impressed on the first liquid crystal layer. In addition, taking f_{d2} to be the focal length of the second diffraction lens, f_{d2} varies in three steps between −3F_{d}, ∞, +3F_{d} in accordance with the voltage impressed on the second liquid crystal layer. The focal length f_{d} of the active diffraction lens 11 is a focal length combining the focal lengths of the two diffraction lenses, and the active diffraction lens 11 selectively generates one out of the nine diffracted lights of differing orders from the incident light in accordance with the voltages impressed on the first and second liquid crystal layers.

When the focal length F_{d} of the lens is sufficiently large compared to the distance between the two diffraction lenses, the relationship 1/f_{d}=1/f_{d1}+1/f_{d2} is established among the focal length f_{d} of the active diffraction lens and the focal lengths f_{d1} and f_{d2} of the two diffraction lenses. The focal length f_{d1} of the first refractive lens varies in three steps between −F_{d}, ∞, +F_{d} in accordance with the voltage impressed on the first liquid crystal layer, and the focal length f_{d2} of the second refractive lens varies in three steps between −3F_{d}, ∞, +3F_{d} in accordance with the voltage impressed on the second liquid crystal layer, so the composite focal length f_{d} of the active diffraction lens 11 varies in nine steps in accordance with the voltages impressed on the first and second liquid crystal layers, as shown in (a) through (i) in FIG. 5.

When recording information on the disc 2a, the state of the active diffraction lens 11a when the beams 24a, 24b and 24c in FIGS. 2A to 2C are selectively generated corresponds to the states (i), (e) and (a), respectively, shown in FIG. 5. In addition, the state of the active diffraction lens 11b when the beams 25a, 25b and 25c in FIGS. 2A to 2C are selectively generated corresponds to the states (a), (e) and (i), respectively, shown in FIG. 5. When reproducing information from the disc 2a, the state of the active diffraction lens 11a when the beams 24a, 24b and 24c in FIGS. 3A to 3C are selectively generated corresponds to the states (i), (e) and (a), respectively, shown in FIG. 5.

Here, the focal length of the objective lenses 14a and 14b is taken to be fₒ, and the position of the focal point of the beams 24b and 25b with the wavelength selection layer 18a as a reference is taken to be ΔF. In addition, Δf is the position of the focus point of the beam selectively generated by the active diffraction lenses 11a and 11b, with the wavelength selection layer 18a as reference. Here, Δf varies in 9 steps with a spacing of fₒ²/3F_{d}, from (−4fₒ²/3F_{d}+ΔF) to (+4fₚ²/3F_{d}+ΔF). For example, when F_{d}=300 mm, fₒ=3 mm and ΔF=50 μm, Δf varies in 9 steps with a spacing of 10 μm from 10 μm to 90 μm.

In the active diffraction lens 11, even if the voltages impressed on the first and second liquid crystal layers fluctuates somewhat, the focal lengths of the two diffraction lenses do not fluctuate, with only moderate fluctuation in the diffraction efficiency of the first and second diffraction lenses. Consequently, even if the impressed voltage fluctuates somewhat, the above-described Δf does not vary accompanying this. This Δf determines the position of the focus point of the beam 24 (FIGS. 2A to 2C, FIGS. 3A to 3C), so even if the voltage impressed on the liquid crystal layers fluctuates somewhat, the spacing between the position of the focus point of the beam 26 and the position of the focus point of the beam 24 does not fluctuate. Accordingly, by controlling the voltage impressed on the first and second liquid crystal layers in accordance with the layer where recording/reproducing should occur, the focus spot of the recording/reproducing beam can be accurately positioned at the layer where recording/reproducing should occur.

The active diffraction lens 11 shown in FIG. 4 is composed of a first and a second diffraction lens that selectively generate one out of a −1 order diffraction light, a 0 order diffraction light and a +1 order diffraction light from the incident light. By varying the focal length f_{d1} of the first diffraction lens in three steps between −F_{d}, ∞, +F_{d} and varying the focal length f_{d2} of the second diffraction lens in three steps between −3F_{d}, ∞, +3F_{d}, Δf is varied in 9 steps with a spacing of fₒ²/3F_{d}, from (−4fₒ²/3F_{d}+ΔF) to (+4fₒ²/3F_{d}+ΔF). By using this kind of active diffraction lens 11, recording/reproducing information is possible in nine locations (nine layers) in the vertical direction of the recording layer 17a (FIGS. 2A to 2C, FIGS. 3A to 3C).

The composition of the active diffraction lens 11 is not limited to the composition shown in FIG. 4, for other compositions are possible as well. For example, the active diffraction lens can be composed of first, second and third diffraction lenses that selectively generate one out of a −1 order diffraction light, a 0 order diffraction light and a +1 order diffraction light from the incident light. In this case, by varying the focal length of the first diffraction lens in three steps between −F_{d}, ∞, +F_{d}, varying the focal length of the second diffraction lens in three steps between −3F_{d}, ∞, +3F_{d}, and varying the focal length of the third diffraction lens in three steps between −9F_{d}, ∞, +9F_{d}, Δf is varied in 27 steps with a spacing of fₒ²/9F_{d}, from (−13fₒ²/9F_{d}+ΔF) to (+13fₒ²/9F_{d}+F). By using an active diffraction lens with this kind of composition, recording/reproducing information is possible in 27 layers.

In addition, in place of the above description, the active diffraction lens can be composed of first and second diffraction lenses that selectively generate one out of five diffraction lights from the incident light, namely a −2 order diffraction light, a −1 order diffraction light, a 0 order diffraction light, a +1 order diffraction light and a +2 order diffraction light. In this case, by varying the focal length of the first diffraction lens in five steps between −F_{d}/2, −F_{d}, ∞, +F_{d} and +F_{d}/2 and varying the focal length of the second diffraction lens in five steps between −5F_{d}/2, −5F_{d}, ∞, +5F_{d} and +5F_{d}/2, Δf can be varied in 25 steps with a spacing of fₒ²/5F_{d}, from −12fₒ²/5F_{d}+ΔF to +12fₒ²/5F_{d}+ΔF. By using an active diffraction lens with this kind of composition, recording/reproducing information is possible in 25 layers.

Furthermore, the active diffraction lens may also have a composition using electro-optic crystals. For example, the active diffraction lens may be composed using lithium niobate as the electro-optic crystal and using one type of diffraction lens that acts on two types of beams with mutually orthogonal polarization directions when a voltage is impressed in a direction parallel to the optical axis and a beam is incident in a direction parallel to the optical axis. This diffraction lens acts as a concave lens on both of the two beams, does not act as a lens on either, or acts as a concave lens on both in accordance with the voltage impressed on the electro-optic crystal.

It is also possible for the active diffraction lens to be composed using two types of diffraction lenses that respectively act on two types of beams with mutually orthogonal polarization directions using liquid crystal layers in the active diffraction lens. In this case, although the speed of varying the focal length of the active diffraction lens is slow, it is possible to vary the focal length at low impressed voltages. In contrast, when an electro-optic crystal is used in the active diffraction lens, the impressed voltage for varying the focal length of the active diffraction lens is high but it is possible to vary the focal length at high speed.

In the composition shown in FIG. 4, the first diffraction lens and the second diffraction lens have a diffraction lens that acts on a first linearly polarized light and a diffraction lens that acts on a second linearly polarized light, respectively. This is because the polarization direction of outbound light (light incident from the mirror 8a side) incident on the active diffraction lens 11a positioned in the optical path of light reflected by the polarizing beam splitter 7a and the polarization direction of inbound light (light incident from the convex lens 4b side) differ by 90°. Accordingly, if the inbound light is not given consideration in light transmitted by the polarizing beam splitter 7a, it is not necessary in the active diffraction lens 11b for the first diffraction lens and the second diffraction lens to have a diffraction lens that acts on the first linearly polarized light and a diffraction lens that acts on the second linearly polarized light, respectively.

The positions of the main planes of the active diffraction lenses 11a and 11b match the positions of the planes optically conjugate to the front side focal planes of the objective lenses 14a and 14b, respectively. In other words, the main plane of the active diffraction lens 11a and the front side focal plane of the objective lens 14a are in optically conjugate positions with respect to the relay lens system composed of the convex lenses 4b and 4c. In addition, the main plane of the active diffraction lens 11b and the front side focal plane of the objective lens 14b are in optically conjugate positions with respect to the relay lens system composed of the convex lenses 4d and 4e. At this time, by opening apertures at the positions of the main planes of the active diffraction lenses 11a and 11b, the aperture number of the objective lenses 14a and 14b does not vary even when the focal lengths of the active diffraction lenses 11a and 11b are varied.

Which out of the nine beams including the beams 24a to 24c and the nine beams including the beams 25a to 25c is selectively generated is switched by the active diffraction lenses 11a and 11b, respectively. Through this switching, the magnification of the objective lenses 14a and 14b on the selectively generated beam varies, and the spherical aberration in the objective lenses 14a and 14b varies. In addition, the optical path length to the focus point from the surface of the substrates 21a and 21b of the disc 2a varies for the selectively generated beam, and the spherical aberration in the disc 2a varies.

In the optical unit, the objective lens 14a is designed so that when the beam 24b (FIGS. 2A to 2C, FIGS. 3A to 3C) incident as parallel light on the objective lens 14a is focused to the focus point 22b, the sum of the spherical aberration in the objective lens 14a and the spherical aberration in the disc 2a is 0. In addition, the objective lens 14b is designed so that when the beam 25b (FIGS. 2A to 2C) incident as parallel light on the objective lens 14b is focused to the focus point 22b, the sum of the spherical aberration in the objective lens 14b and the spherical aberration in the disc 2a is 0.

When the lens power of the active diffraction lenses 11a and 11b is varied, the amount of variance in the magnification of the objective lenses 14a and 14b is proportional to the lens power of the active diffraction lenses 11a and 11b, respectively. Consequently, the amount of variance in the spherical aberration in the objective lenses 14a and 14b accompanying the variance in magnification of the objective lenses 14a and 14b is proportional to the lens power of the active diffraction lenses 11a and 11b, respectively. In addition, the amount of variance in the optical path length from the surface of the substrates 21a and 21b in the disc 2a to the focus point is proportional to the lens power of the active diffraction lenses 11a and 11b, respectively. Consequently, the amount of variance in the spherical aberration in the disc 2a accompanying the variance in the optical path length from the surface of the substrates 21a and 21b in the disc 2a to the focus point is proportional to the lens power of the active diffraction lenses 11a and 11b, respectively.

The lens power of the active diffraction lenses 11a and 11b when the state of the active diffraction lenses 11a and 11b corresponds to the states in (a) through (i) of FIG. 5 is expressed by m×1/3F_{d}. Here, the values of m in the states of (a) through (i) in FIG. 5 are −4 to +4, respectively. Accordingly, the amount of variance in the spherical aberration in the objective lenses 14a and 14b accompanying the variance in the magnification of the objective lenses 14a to 14b can be expressed by m×SAₒ, where SAₒ is the spherical aberration of the objective lens. In addition, the amount of variance in the spherical aberration in the disc 2a accompanying the variance in the optical path length from the surface of the substrates 21a and 21b in the disc 2a to the focus point can be expressed by m×SAₘ, where SAₘ is the spherical aberration of the disc 2a.

When a spherical aberration is generated in the active diffraction lenses 11a and 11b, the generation amount of the spherical aberration in the active diffraction lenses 11a and 11b is proportional to the lens power of the active diffraction lenses 11a and 11b, respectively, and thus can be expressed by m×SA_{d}. At this time, the sum of the amount of variance in the spherical aberration in the objective lenses 14a and 14b, the amount of variance in the spherical aberration in the disc 2a and the amount of variance in the spherical aberration in the active diffraction lenses 11a and 11b becomes m×(SAₒ+SAₘ+SA_{d}). Here, the generation amount of the spherical aberration in the active diffraction lenses 11a and 11b is determined so that SA_{d}=−(SAₒ+SAₘ). Through this spherical aberration, it is possible to eliminate the spherical aberrations generated in the objective lenses 14a and 14b and the disc 2a in accordance with variance in the lens power of the active diffraction lenses 11a and 11b using the spherical aberration generated in the active diffraction lenses 11a and 11b.

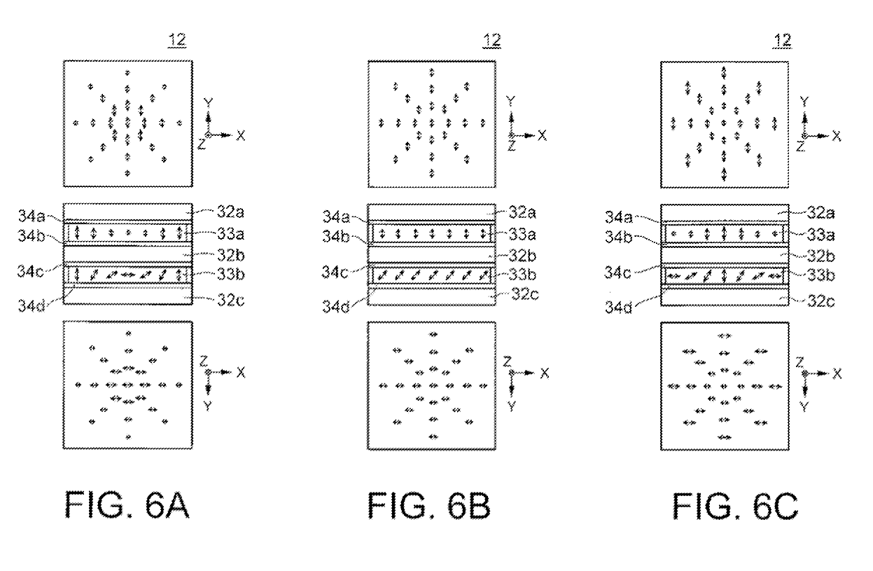

Next, the variable focus lens is described. FIGS. 6A to 6C show cross-sections of the variable focus lenses 12a and 12b. Here, the variable focus lenses 12a and 12b are explained as a variable focus lens 12. The variable focus lens 12 is comprised with a liquid crystal layer 33a interposed between substrates 32a and 32b, and a liquid crystal layer 33b interposed between substrates 32b and 32c. On the surfaces of the substrates 32a and 32b on the side toward the liquid crystal layer 33a, transparent electrodes 34a and 34b, respectively, are formed for impressing alternating voltages on the liquid crystal layer 33a. In addition, on the surfaces of the substrates 32b and 32c on the side toward the liquid crystal layer 33b, transparent electrodes 34c and 34d, respectively, are formed for impressing alternating voltages on the liquid crystal layer 33b.

The transparent electrodes 34a and 34c are pattern electrodes and the transparent electrodes 34b and 34d are full-surface electrodes. The liquid crystal layer 33a and the transparent electrodes 34a and 34b comprise a first variable focus lens, and the liquid crystal layer 33b and the transparent electrodes 34c and 34d comprise a second variable focus lens. The first variable focus lens acts on first linearly polarized light whose polarization direction is a first direction. The second variable focus lens acts on second linearly polarized light whose polarization direction is a second direction orthogonal to the first direction. Glass, for example, may be used as the material of the substrates 32a to 32c. Nematic liquid crystal, for example, may be used as the material of the liquid crystal layers 33a and 33b. ITO, for example, may be used as the material of the transparent electrodes 34a to 34d.

The liquid crystal layers 33a and 33b have a single-axis refractive anisotropy. Calling n_{θ} and nₒ respectively the refractive indices of polarized light components in the direction parallel to and the direction orthogonal to the optical axis of the liquid crystal layers 33a and 33b, n_{θ}>nₒ establishes. The arrows shown in FIGS. 6A to 6C indicate the direction of the optical axis of the liquid crystal layers 33a and 33b. The optical axis of the liquid crystal layer 33a is in the Y-Z plane, and the optical axis of the liquid crystal layer 33b is in the X-Z plane.

The first variable focus lens acts on linearly polarized light whose polarization direction is the Y-axis direction, and does not act on linearly polarized light whose polarization direction is the X-axis direction. On the other hand, the second variable focus lens acts on linearly polarized light whose polarization direction is the X-axis direction, and does not act on linearly polarized light whose polarization direction is the Y-axis direction. When recording information, the beam emitted from the laser 3a and reflected by the polarizing beam splitter 7a, and the beam emitted from the laser 3a and transmitted by the polarizing beam splitter 7a are incident on the liquid crystal layers 33a and 33b as linearly polarized light whose polarization direction is the Y-axis direction and the X-axis direction, respectively. In addition, when reproducing information from the disc 2a, the beam emitted from the laser 3a and reflected by the polarizing beam splitter 7a and the beam reflected by the disc 2a and transmitted by the polarizing beam splitter 7a are incident on the liquid crystal layers 33a and 33b as linearly polarized light whose polarization direction is the Y-axis direction and the X-axis direction, respectively.

The transparent electrodes 34a and 34c are split into multiple electrodes of annular shape. Each electrode is connected by resistance to the neighboring electrode. In the variable focus lens 12, mutually differing alternating voltages are impressed on the center and the perimeter of the liquid crystal layers 33a and 33b using the inside-most electrode and the outside-most electrode. By impressing alternating voltages in this manner, an alternating voltage distribution that is a second-order function is formed from the center toward the perimeter.

FIG. 6A illustrates the state when an alternating voltage with an effective value of (2.5−Δ) V is impressed on the center and an effective value of (2.5+Δ) V is impressed on the perimeter of the liquid crystal layer 33a, and an alternating voltage with an effective value of (2.5−Δ) V is impressed on the center and an effective value of (2.5+Δ) V is impressed on the perimeter of the liquid crystal layer 33b. In this state, the optical axis of the liquid crystal layer 33a is in a direction close to the Y-axis direction at the center and is in a direction close to the Z-axis direction at the perimeter, and the optical axis of the liquid crystal layer 33b is in a direction close to the X-axis direction at the center and is in a direction close to the Z-axis direction at the perimeter. Accordingly, the refractive index of the liquid crystal layer 33a on linearly polarized light whose polarization direction is the Y-axis direction is high at the center and low at the perimeter, and the refractive index of the liquid crystal layer 33b on linearly polarized light whose polarization direction is the X-axis direction is high at the center and low at the perimeter. As a result, the first variable focus lens acts as a convex lens on linearly polarized light whose polarization direction is the Y-axis direction and the second variable focus lens acts as a convex lens on linearly polarized light whose polarization direction is the X-axis direction. Here, the focal length of the first variable focus lens and the focal length of the second variable focus lens are equal. The larger Δ is, the smaller the absolute value of the focal length of the first and second variable focus lenses becomes.

FIG. 6B illustrates the state when an alternating voltage with an effective value of 2.5 V is impressed on the center and on the perimeter of the liquid crystal layer 33a, and an alternating voltage with an effective value of 2.5 V is impressed on the center and on the perimeter of the liquid crystal layer 33b. In this state, the optical axis of the liquid crystal layer 33a is in a direction midway between the Y-axis direction and the Z-axis direction at both the center and the perimeter, and the optical axis of the liquid crystal layer 33b is in a direction midway between the X-axis direction and the Z-axis direction at both the center and the perimeter. Accordingly, the refractive index of the liquid crystal layer 33a on linearly polarized light whose polarization direction is the Y-axis direction is equal at the center and at the perimeter, and the refractive index of the liquid crystal layer 33b on linearly polarized light whose polarization direction is the X-axis direction is equal at the center and at the perimeter. As a result, the first variable focus lens does not act as a lens on linearly polarized light whose polarization direction is the Y-axis direction and the second variable focus lens does not act as a lens on linearly polarized light whose polarization direction is the X-axis direction.

FIG. 6C illustrates the state when an alternating voltage with an effective value of (2.5+Δ) V is impressed on the center and an effective value of (2.5−Δ) V is impressed on the perimeter of the liquid crystal layer 33a, and an alternating voltage with an effective value of (2.5+Δ) V is impressed on the center and an effective value of (2.5−Δ) V is impressed on the perimeter of the liquid crystal layer 33b. In this state, the optical axis of the liquid crystal layer 33a is in a direction close to the Z-axis direction at the center and is in a direction close to the Y-axis direction at the perimeter, and the optical axis of the liquid crystal layer 33b is in a direction close to the Z-axis direction at the center and is in a direction close to the X-axis direction at the perimeter. Accordingly, the refractive index of the liquid crystal layer 33a on linearly polarized light whose polarization direction is the Y-axis direction is low at the center and high at the perimeter, and the refractive index of the liquid crystal layer 33b on linearly polarized light whose polarization direction is the X-axis direction is low at the center and high at the perimeter. As a result, the first variable focus lens acts as a concave lens on linearly polarized light whose polarization direction is the Y-axis direction and the second variable focus lens acts as a concave lens on linearly polarized light whose polarization direction is the X-axis direction. Here, the focal length of the first variable focus lens and the focal length of the second variable focus lens are equal. The larger Δ is, the smaller the absolute value of the focal length of the first and second variable focus lenses becomes.

The variable focus lenses 12a and 12b are controlled in accordance with the direction in which the focus points of the beam 24 (FIGS. 2A to 2C, FIGS. 3A to 3C), the beam 25 and the beam 26 are to be moved, when recording information on the disc 2a and when reproducing information from the disc 2a. For example, when the variable focus lens 12a is in the state shown in FIG. 6B, the variable focus lens 12a is caused to vary from the state in FIG. 6B to the state in FIG. 6A when moving the position of the focus point of the beam 24 and the beam 26 closer to the objective lens 14a. At this time, the variable focus lens 12b is varied from the state shown in FIG. 6B to the state shown in the FIG. 6C and the position of the focus point of the beam 25 approaches the objective lens 14a side.

Conversely, the variable focus lens 12a is caused to vary from the state in FIG. 6B to the state in FIG. 6C when moving the position of the focus point of the beam 24 and the beam 26 in the direction away from the objective lens 14a. At this time, the variable focus lens 12b is varied from the state shown in FIG. 6B to the state shown in the FIG. 6A and the position of the focus point of the beam 25 moves away from the objective lens 14a. By varying the focal length of the variable focus lens 12a, it is possible to move the recording/reproducing beam 24 and the focus control beam 26 the same distance in a direction of a thickness of the recording layer 17a.

The above description explained the composition using a liquid crystal layer in the variable focus lens 12, but it is also possible to utilize a composition using an electro-optical crystal in the variable focus lens 12. For example, the variable focus lenses 12a and 12b using lithium niobate as the electro-optical crystal are adopted. These variable focus lenses 12a and 12b are comprised of one type of variable focus lens that acts on two types of beams with mutually orthogonal polarization directions when a voltage is impressed in a direction parallel to the optical axis and a beam is incident in a direction parallel to the optical axis. This variable focus lens acts as a convex lens on the two types of beams, does not act as a lens on either, or acts as a concave lens on both in accordance with the voltage impressed on the electro-optical crystal.

It is also possible to compose a variable focus lens 12 by two types of variable focus lens that respectively act on two types of beams having mutually orthogonal polarization directions, using a liquid crystal layer in the variable focus lens 12. In this case, the speed of varying the focal length of the variable focus lens is slow, but it is possible to vary the focal length with low impressed voltages. In contrast, when an electro-optical crystal is used in the variable focus lens, the impressed voltage when varying the focal length of the variable focus lens is high, but it is possible to vary the focal length at high speed.

The positions of the main planes of the variable focus lenses 12a and 12b match the positions of the front side focal planes of the objective lenses 14a and 14b, respectively. At this time, by opening apertures at the positions of the main planes of the variable focus lenses 12a and 12b, the aperture number of the objective lenses 14a and 14b does not vary even when the focal length of the variable focus lenses 12a and 12b is varied.

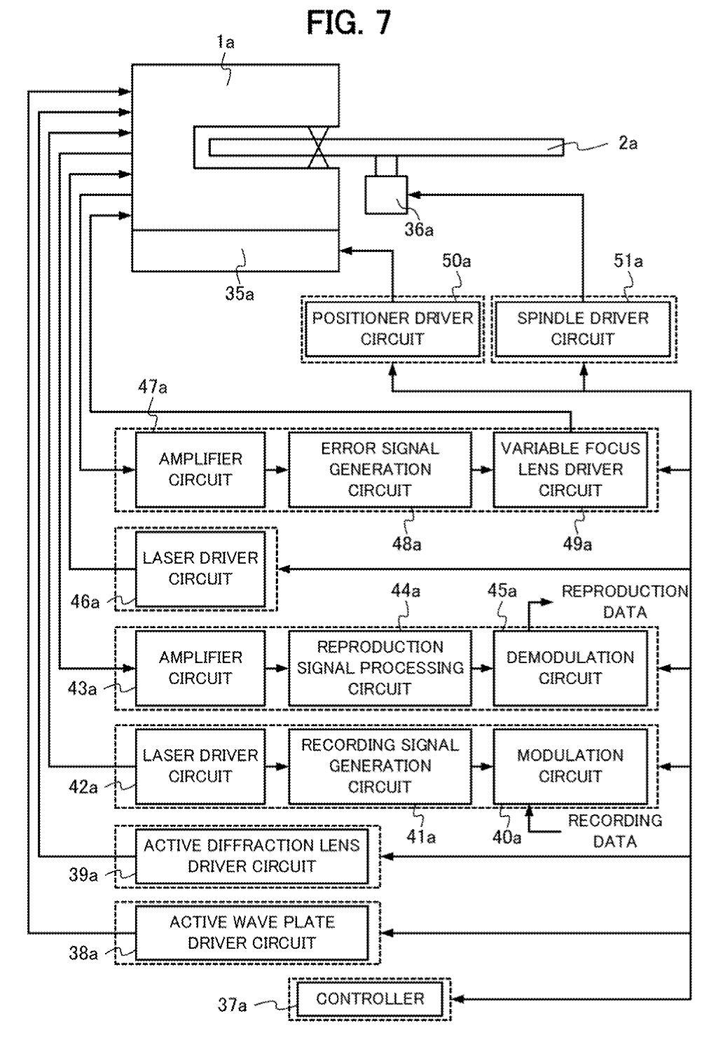

FIG. 7 shows an optical information recording/reproducing device that includes the optical unit shown in FIG. 1. The optical information recording/reproducing device has an optical unit 1a, a positioner 35a, a spindle 36a, a controller 37a, an active wave plate driver circuit 38a, an active diffraction lens driver circuit 39a, a modulation circuit 40a, a recording signal generation circuit 41a, a laser driver circuit 42a, an amplifier circuit 43a, a reproduction signal processing circuit 44a, a demodulation circuit 45a, a laser driver circuit 46a, an amplifier circuit 47a, an error signal generation circuit 48a, a variable focus lens driver circuit 49a, a positioner driver circuit 50a and a spindle driver circuit 51a.

The optical unit 1a has the composition shown in FIG. 1. The optical unit 1a is mounted on the positioner 35a and the disc 2a is mounted on the disc 2a. The controller 37a controls the active wave plate driver circuit 38a, the active diffraction lens driver circuit 39a, the circuits from the modulation circuit 40a to the laser driver circuit 42a, the circuits from the amplifier circuit 43a to the demodulation circuit 45a, the laser driver circuit 46a, the circuits from the amplifier circuit 47a to the variable focus lens driver circuit 49a, the positioner driver circuit 50a and the spindle driver circuit 51a.

The active wave plate driver circuit 38a is a beam switching unit driver circuit for driving the active wave plate 5a, which is the beam switching unit in the optical unit 1a. The active wave plate driver circuit 38a accomplishes control such that when recording information on the disc 2a an alternating voltage with an effective value of 2.5 V is impressed on the liquid crystal layer possessed by the active wave plate 5a in the optical unit 1a and the active wave plate 5a functions as a quarter-wave plate. The active wave plate driver circuit 38a accomplishes control such that when reproducing information from the disc 2a an alternating voltage is not impressed on the liquid crystal layer possessed by the active wave plate 5a in the optical unit 1a and the active wave plate 5a functions as a half-wave plate. The active wave plate driver circuit 38a makes the recording/reproducing beam two beams that are focused at the same position from mutually opposite directions in the recording layer of the disc 2a when recording information on the disc 2a. On the other hand, the active wave plate driver circuit 38a makes the recording/reproducing beam a single beam when reproducing information from the disc 2a.

The active diffraction lens driver circuit 39a is a first focus position varying circuit that drives the active diffraction lens 11a, which is a first lens system in the optical unit 1a. The active diffraction lens driver circuit 39a impresses an alternating voltage with an effective value of either 0 V, 2.5 V or 5 V on the liquid crystal layers 28a to 28d possessed by the active diffraction lens 11a in the optical unit 1a when recording information to the disc 2a and when reproducing information from the disc 2a. The active diffraction lens driver circuit 39a accomplishes control so that the active diffraction lens 11a selectively generates one out of the nine types of beams containing the beams 24a to 24c by impressing this alternating voltage.

The active diffraction lens driver circuit 39a impresses an alternating voltage with an effective value of 0 V, 2.5 V or 5 V on the liquid crystal layers 28a to 28d possessed by the active diffraction lens 11b when recording information to the disc 2a. The active diffraction lens driver circuit 39a accomplishes control so that the active diffraction lens 11b selectively generates one out of the nine types of beams containing the beams 25a to 25c by impressing this alternating voltage. The active diffraction lens driver circuit 39a controls the active diffraction lenses 11a and 11b in accordance with the recording/reproducing position in a direction of a thickness of the disc 2a, and causes the focus position of the recording/reproducing beam to vary in accordance with the recording/reproducing position.

The modulation circuit 40a modulates signals input from the outside as recording data in accordance with a prescribed modulation rule when recording information on the disc 2a. The recording signal generation circuit 41a generates a recording signal for driving the laser 3a in the optical unit 1a on the basis of the signal modulated by the modulation circuit 40a. The laser driver circuit 42a drives the laser 3a that emits the recording/reproducing beam. The laser driver circuit 42a drives the laser 3a by supplying an electric current in accordance with the recording signal of the laser 3a on the basis of the recording signal generated by the recording signal generation circuit 41a when recording information on the disc 2a. In addition, the laser driver circuit 42a drives the laser 3a by supplying a constant electric current to the laser 3a so that the power of the light emitted from the laser 3a is a constant when reproducing information from the disc 2a.

The amplifier circuit 43a amplifies the voltage signal output from the light detector 15a in the optical unit 1a when reproducing information from the disc 2a. The reproduction signal processing circuit 44a generates, equalizes the waveform of and converts to binary values the reproduction signal recorded by the configuration of the diffraction grating on the disc 2a on the basis of the voltage signal amplified by the amplifier circuit 43a. The demodulation circuit 45a demodulates the signal converted to binary by the reproduction signal processing circuit 44a in accordance with a demodulation rule, and outputs this to the outside as reproduced data.

The laser driver circuit 46a drives the laser 3c that emits the focus control beam in the optical unit 1a. The laser driver circuit 46a supplies a constant electric current to the laser 3c in the optical unit 1a and causes a focus control beam of prescribed power to be emitted from the laser 3c when recording information on the disc 2a and when reproducing information from the disc 2a.

The amplifier circuit 47a amplifies the voltage signal corresponding to the light output from the light detector 15c in the optical unit 1a and the light of the focus control beam reflected from the disc 2a, when recording information to the disc 2a and when reproducing information from the disc 2a. The error signal generation circuit 48a generates a focus error signal for controlling the focus positions of the recording/reproducing beam and the focus control beam in a direction of a thickness of the disc 2a on the basis of the voltage signal amplified by the amplifier circuit 47a.

The variable focus lens driver circuit 49a drives the variable focus lenses 12a and 12b in the optical unit 1a. The variable focus lens driver circuit 49a impresses an alternating voltage on the liquid crystal layers 33a and 33b (FIGS. 6A to 6C) the variable focus lenses have, and drives the variable focus lenses 12a and 12b. The variable focus lens driver circuit 49a is a second focus position varying circuit that drives the variable focus lens 12a, which is a second lens system, on the basis of the focus error signal and varies the positions of the focus points of the recording/reproducing beam and the focus control beam in a direction of a thickness of the disc 2a. The variable focus lens driver circuit 49a controls the voltage impressed on the liquid crystal layers 33a and 33b possessed by the variable focus lenses so that the focus error signal generated by the error signal generation circuit 49a becomes 0 and the beam 26a (FIGS. 2A to 2C, FIGS. 3A to 3C) is focused on the wavelength selection layer 18a.

The positioner driver circuit 50a causes the positioner 35a to move in the radial direction of the disc 2a and causes the positions of the focus points of the recording/reproducing beam and the focus control beam to move in the radial direction of the disc 2a when recording information on the disc 2a and when reproducing information from the disc 2a. The spindle driver circuit 51a supplies electric current to an unrepresented motor and causes the spindle 36a to rotate, thereby causing the positions of the focus points of the recording/reproducing beam and the focus control beam to move in the tangential direction of the disc 2a, when recording information on the disc 2a and when reproducing information from the disc 2a.

In the present embodiment, the optical unit 1a has a first lens system (the active diffraction lens 11a) that discretely varies, in a direction of a thickness of the recording layer, the position of focus point of the recording/reproducing beam focused in the recording layer of the disc 2a using the objective lens 14a, in the optical path of the recording/reproducing beam. In addition, the optical unit 1a has a second optical system (the variable focus lens 12a) capable of discretely varying, in a direction of a thickness of the disc 2a, the positions of the focus points of the recording/reproducing beam and the focus control beam that are focused using the objective lens, in the optical path common to the recording/reproducing beam and the focus control beam. The optical information recording/reproducing device has a first focus position varying circuit (active diffraction lens driver circuit 39a) that drives the first lens system and discretely varies the focus position of the recording/reproducing beam, the error signal generation circuit 48a for generating focus error signals, and a second focus position varying circuit (the variable focus lens driver circuit 49a) for driving the second lens system on the basis of the focus error signal and continuously varying the focus positions of the recording/reproducing beam and the focus control beam.

When recording/reproducing information on multiple layers in a direction of a thickness of the recording layer on the disc 2a, the position of the focus control beam is determined on the focus control reference surface of the disc 2a by driving the second lens system so that the focus error signal generated using the focus control beam becomes 0. At this time, the position of the focus spot of the recording/reproducing beam is discretely varied in a direction of a thickness of the disc 2a using the first lens system, switching on which layer the focus spot of the recording/reproducing beam is positioned. The discrete variation amount of the position of the recording/reproducing beam when using the first lens system is determined in accordance with the properties of the first lens system and is not dependent on the aberration the optical unit possesses. Accordingly, the position where recording/reproducing should be accomplished and the position of the focus spot of the recording/reproducing beam that is varied using the first lens position can be made to match in a direction of a thickness of the recording layer on the disc 2a, making it possible to correctly position the position of the focus spot of the recording/reproducing beam on the layer where recording/reproducing should be accomplished. As a result, it is possible to correctly reproduce with a different optical unit information recorded on the disc 2a using a given optical unit. That is to say, it is possible to ensure interchangeability of the disc 2a between multiple optical units and optical information recording/reproducing devices.

The composition of the optical unit is not limited to that shown in FIG. 1. The optical unit may have parallel tracks formed in the tangential direction of the disc 2a on the wavelength selection layer 18a (FIGS. 2A to 2C, FIGS. 3A to 3C) of the disc 2a, and a polarizing unit capable of varying the focus positions of the recording/reproducing beam and the focus control beam in the radial direction of the disc 2a may be provided in the optical unit 1a. This polarizing unit can use polarizing elements having liquid crystal layers. In addition, an optical information recording/reproducing device equipped with such an optical unit has the following composition in the composition shown in FIG. 7. That is to say, a second error signal generation circuit that generates track error signals for controlling the focus positions of the recording/reproducing beam and the focus control beam in the radial direction of the disc 2a, and a third focus position varying circuit that drives the polarizing unit on the basis of the track error signal, are added to the composition of FIG. 7.

The second error signal generation circuit generates a track error signal for driving the polarizing elements in the optical unit 1a on the basis of the voltage signal that is the output of the light detector 15c amplified by the amplifier circuit 47a. The polarizing element driver circuit that is the third focus position varying circuit controls the polarizing element on the basis of the track error signal generated by the second error signal generation circuit and causes the focus positions of the recording/reproducing beam and the focus control beam to vary. The polarizing element driver circuit controls the alternating voltage impressed on the liquid crystal layers the polarizing element possesses, and controls the position of the focus point of the beam 26a in the radial direction of the disc 2a so that the track error signal becomes 0. By doing this, it is possible to focus the beam 26a on a track formed in the wavelength selection layer 18a.

In addition, it is possible to use a similar composition to the optical unit disclosed in Non-Patent Literature 1, that is to say a composition in which the optical unit 1a is equipped with a third light detector, a third lens system and a second polarizing unit. The third light detector receives the recording/reproducing beam transmitted by the disc 2a when recording information on the disc 2a. The third lens system can vary, in a direction of a thickness of the recording layer 17a, the focus position of the beam that is emitted from the laser 3a and transmitted by the polarizing beam splitter 7a, and the second polarizing unit can vary the focus position of the beam transmitted by the polarizing beam splitter 7a in the radial direction and the tangential direction of the disc 2a. In the third lens system, it is possible to use the variable focus lens 12b. In the second polarizing unit, it is possible to use the second polarizing element having liquid crystal layers.

In addition, the optical information recording/reproducing device equipped with an optical unit having the above-described third light detector has the following composition added to the composition shown in FIG. 7. That is to say, a third amplifier circuit for amplifying the output of the third light detector, a position deviation signal generation circuit, a fourth focus position varying circuit for driving the third lens system and a fifth focus position varying circuit for driving the second polarizing unit may be added to the composition of FIG. 7. The third amplifier circuit amplifies the voltage signal output from the third light detector in the optical unit 1a when recording information to the disc 2a. The position deviation signal generation circuit generates a position deviation signal for controlling the focus position of the beam emitted from the laser 3a and transmitted by the polarizing beam splitter 7a in a direction of a thickness of the recording layer 17a and the radial direction and the tangential direction of the disc 2a, relative to the focus position of the beam reflected by the polarizing beam splitter 7a. Here, the position deviation signal generation circuit generates the position deviation signal on the basis of the output from the third light detector amplified by the third amplifier circuit.

The fourth focus position varying circuit is a second variable focus lens driver circuit for driving the variable focus lens 12b. The second variable focus lens driver circuit impresses an alternating voltage on the liquid crystal layers 33a and 33b (FIGS. 6A to 6C) the variable focus lens 12b possesses. By impressing this alternating voltage, the relative focus position of the beam emitted from the laser 3a and transmitted by the polarizing beam splitter 7a is controlled in a direction of a thickness of the recording layer relative to the focus position of the beam emitted from the laser 3a and reflected by the polarizing beam splitter 7a. The second variable focus lens driver circuit drives the variable focus lens 12b so that the position deviation signal becomes 0. That is to say, the second variable focus lens driver circuit drives the variable focus lens 12b so that the focus position of the beam emitted from the laser 3a and reflected by the polarizing beam splitter 7a and the focus position of the beam transmitted by the polarizing beam splitter 7a match in a direction of a thickness of the recording layer.

The fifth focus position varying circuit is the second polarizing element driver circuit for driving the second polarizing element. The second polarizing element driver circuit impresses an alternating voltage on the liquid crystal layers the second polarizing element possesses. By impressing this alternating voltage, the relative focus position of the beam emitted from the laser 3a and transmitted by the polarizing beam splitter 7a is controlled in the radial direction and the tangential direction of the disc relative to the focus position of the beam emitted from the laser 3a and reflected by the polarizing beam splitter 7a. The second polarizing element driver circuit drives the second polarizing element so that the position deviation signal generated by the position deviation signal generation circuit becomes 0. That is to say, the second polarizing element driver circuit drives the second polarizing element so that the focus position of the beam emitted from the laser 3a and reflected by the polarizing beam splitter 7a and the focus position of the beam transmitted by the polarizing beam splitter 7a match in the radial direction and the tangential direction of the disc. Driving the variable focus lens 12a and the second polarizing element by the second variable focus lens driver circuit and the second polarizing element driver circuit can focus the beam emitted from the laser 3a and reflected by the polarizing beam splitter 7a and the beam transmitted by the polarizing beam splitter 7a in the same position in the recording layer.

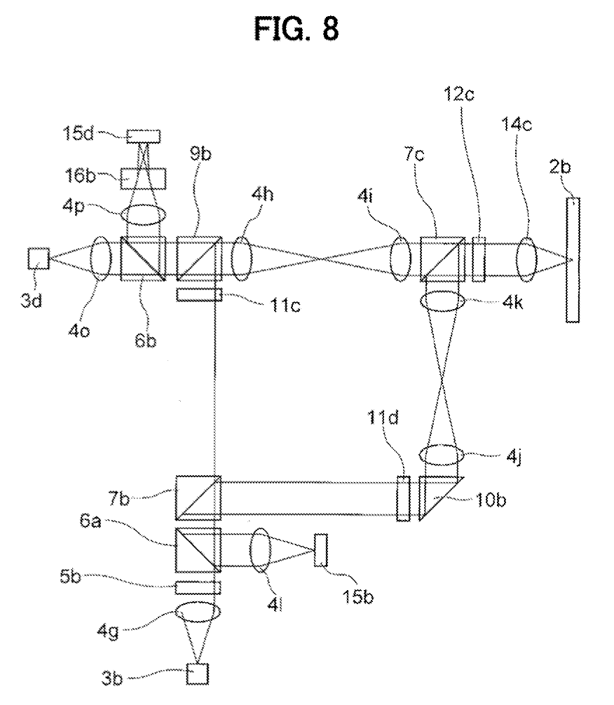

A second embodiment of the present invention is described below. FIG. 8 shows the optical unit of the second embodiment of the present invention. The optical unit has lasers 3b and 3d, convex lenses 4g to 41, 4o and 4p, an active wave plate 5b, half-silvered mirrors 6a and 6b, polarizing beam splitters 7b and 7c, an interference filter 9b, a mirror 10b, active diffraction lenses 11c and 11d, a variable focus lens 12c, an objective lens 14c, light detectors 15b and 15d and a cylindrical lens 16b.

The light-source lasers 3b and 3d are semiconductor lasers and emit a recording/reproducing beam with a wavelength of 405 nm and a focus control beam with wavelength of 650 mu, respectively. The interference filter 9b reflects the beam with a wavelength of 405 nm and transmits the beam with a wavelength of 650 nm. The polarizing beam splitter 7c transmits the P-polarized component of the beam having a wavelength of 405 nm and reflects the S-polarized component. On the other hand, the polarizing beam splitter 7c transmits both the P-polarized component and the S-polarized component of the beam having a wavelength of 650 nm. The active diffraction lenses 11c and 11d in the first lens system selectively generate one out of the multiple diffraction beams of mutually different orders from the incident beam. The variable focus lens 12c is a second lens system.

The beam emitted from the laser 3b is converted from divergent light into parallel light by passing through the convex lens 4g and is incident on the active wave plate 5b. The active wave plate 5b has the effect of a quarter-wave plate on incident light when recording information on a disc 2b that is an optical recording medium and has the function of a full-wave plate on incident light when reproducing information from the disc 2b. When recording information on the disc 2b, the beam incident on the active wave plate 5b is converted from linearly polarized light into circularly polarized light by passing through the active wave plate 5b. Approximately 50% of this circularly polarized light is transmitted by the half-silvered mirror 6a, and approximately 50% of this transmitted light is transmitted by the polarizing beam splitter 7b as the P-polarized component and the remaining 50% is reflected by the polarizing beam splitter 7b as the S-polarized component. On the other hand, when reproducing information from the disc 2b, the beam incident on the active wave plate 5b is transmitted by the active wave plate 5b without the polarization state changing. Approximately 50% of this transmitted light is transmitted by the half-silvered mirror 6a, following which this light is incident on the polarizing beam splitter 7b as P-polarized light and virtually 100% is transmitted. Here, the active wave plate 5b and the polarizing beam splitter 7b are a beam switching unit.

The active wave plate 5b has a composition in which a liquid crystal layer is interposed between two substrates. Transparent electrodes for impressing alternating voltages on the liquid crystal layers are formed on the liquid crystal layer sides of the two substrates. The liquid crystal layer has a single axis of refractive anisotropy. When an alternating voltage having an effective value of 2.5 V is impressed on the liquid crystal layer, the direction of the optical axis of the liquid crystal layer becomes a direction midway between the direction parallel to and a direction orthogonal to the optical axis of the incident light. At this time, the phase difference between the polarized component in a direction orthogonal to and the polarized component in a direction parallel to a surface containing the optical axis and the optical axis generated in the light transmitted by the liquid crystal layer is π/2, and the active wave plate 5b has a quarter-wave plate function. On the other hand, when an alternating voltage with an effective value of 5V is impressed on the liquid crystal layer, the direction of the optical axis of the liquid crystal layer becomes a direction parallel to the optical axis of the incident light. At this time, the phase difference between the polarized component in a direction orthogonal to and the polarized component in a direction parallel to a surface containing the optical axis and the optical axis generated in the light transmitted by the liquid crystal layer becomes 0, so the active wave plate 5b has the function of a full-wave plate.

When recording information on the disc 2b, the beam transmitted by the polarizing beam splitter 7b is diffracted by the active diffraction lens 11c, is reflected by the interference filer 9b and is transmitted by the relay lens system comprised of the convex lenses 4h and 4i while receiving the action of this as a weak convex lens. Following this, the beam transmitted by the relay lens system is incident as P-polarized light on the polarizing beam splitter 7c and is virtually 100% transmitted, is transmitted by the variable focus lens 12c and is focused on the disc 2b by the objective lens 14c. In addition, the beam reflected by the polarizing beam splitter 7b is diffracted by the active diffraction lens 11d, is reflected by the mirror 10b and is transmitted by the relay lens system composed of the convex lenses 4j and 4k while receiving the action of this as a weak concave lens. The beam transmitted by this relay lens system is incident as S-polarized light on the polarizing beam splitter and is virtually 100% reflected, is transmitted by the variable focus lens 12c and is focused on the disc 2b by the objective lens 14c.

On the other hand, when reproducing information from the disc 2b, the beam transmitted by the polarizing beam splitter 7b is diffracted by the active diffraction lens 11c and is reflected by the interference filter 9b. This reflected light is transmitted by the relay system composed of the convex lenses 4h and 4i while receiving the action of this as a weak convex lens. The beam transmitted by the relay lens system is incident on the polarizing beam splitter 7c as P-polarized light and is virtually 100% transmitted, is transmitted by the variable focus lens 12c and is focused in the disc 2b by the objective lens 14c.

The beam reflected by the disc 2b passes through the objective lens 14c in the opposite direction, is transmitted by the variable focus lens 12c, is incident on and virtually 100% transmitted by the polarizing beam splitter 7c as P-polarized light and is transmitted by the relay lens system composed of the convex lenses 4i and 4h while receiving the action of this as a weak convex lens. The beam transmitted by the relay lens system is reflected by the interference filter 9b, is diffracted by the active diffraction lens 11c and is incident on and virtually 100% transmitted by the polarizing beam splitter 7b as P-polarized light. Approximately 50% of this transmitted light is reflected by the half-silvered mirror 6a, is converted from parallel light into convergent light by passing through the convex lens 41 and is received by the light detector 15b. A reproduction signal that is information that was recorded on the disc 2b is generated on the basis of the output from the light detector 15b.

The beam emitted from the laser 3d is converted from divergent light into weakly divergent light by passing through the convex lens 4o and approximately 50% of this is transmitted by the half-silvered mirror 6b. This transmitted light is transmitted by the interference filter 9b and is transmitted by the relay lens system composed of the convex lenses 4h and 4i while receiving the action of this as a weakly convex lens. The light transmitted by the relay lens system is transmitted by the polarizing beam splitter 7c, is transmitted by the variable focus lens 12c and is focused on the disc 2b by the objective lens 14c. The beam reflected by the disc 2b passes through the objective lens 14c in the opposite direction, is transmitted by the variable focus lens 12c, is transmitted by the polarizing beam splitter 7c and is transmitted by the relay lens system composed of the convex lenses 4i and 4h while receiving the action of this as a weak convex lens. The light transmitted by the relay lens system is transmitted by the interference filter 9b, approximately 50% of this reflected by the half-silvered mirror 6b, is converted from weakly convergent light into convergent light by passing through the convex lens 4p, is transmitted by the cylindrical lens 16b and given astigmatism, and is received by the light detector 15d. A focus error signal for controlling the focus positions of the recording/reproducing beam and the focus control beam in a direction of a thickness of the recording layer on the disc 2b is generated on the basis of the output from this light detector 15d. The focus error signal is generated by a commonly known astigmatism method.

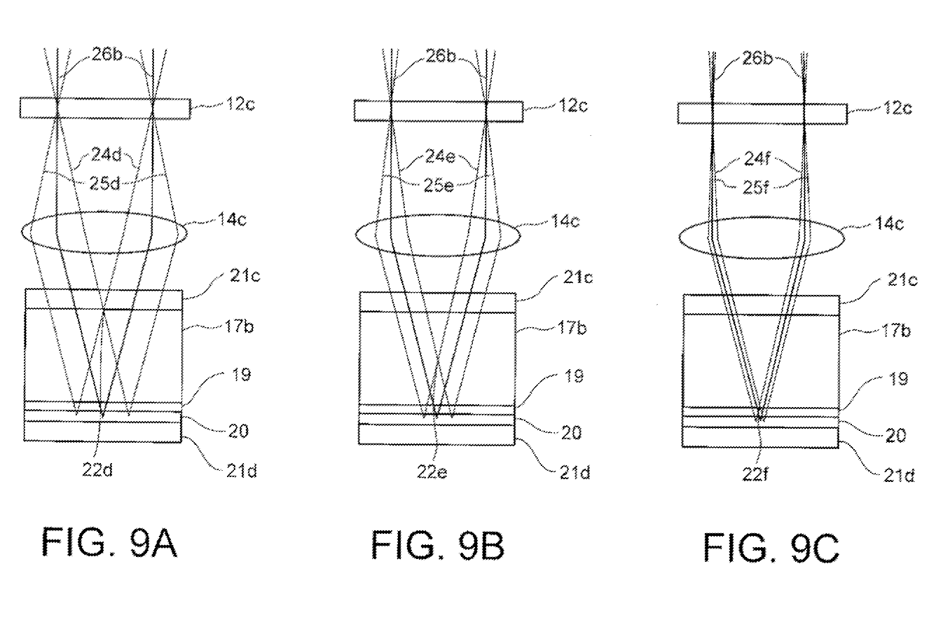

FIGS. 9A to 9C show the beam incident on the disc 2b and the beam reflected from the disc 2b when recording information on the disc 2b. The disc 2b has a composition in which a recording layer 17b, a quarter-wave plate layer 19 and a reflective layer 20 are interposed in this order between substrates 21c and 21d. The quarter-wave plate layer 19 has the effect of a quarter-wave plate on beams with a wavelength of 405 nm and has the function of a full-wave plate on beams with a wavelength of 650 nm. The reflective layer 20 is a focus control reference surface. Glass, for example, may be used as the material of the substrates 21c and 21d. A photopolymer, for example, may be used as the material of the recording layer 17b. Liquid crystal, for example, may be used as the material of the quarter-wave play layer 19. Aluminum, for example, may be used as the material of the reflective layer 20.

The beam 24 (24d to 24f) and the beam 25 (25d to 25f) in the FIGS. 9A to 9C are recording/reproducing beams. The beams 24d to 24f illustrate beams selectively generated by the active diffraction lens 11c from beams emitted from the laser 3b and transmitted by the polarizing beam splitter 7b when recording information on the disc 2b. The beams 25d to 25f in FIGS. 9A to 9C illustrate beams selectively generated by the active diffraction lens 11d from the beam emitted from the laser 3b and reflected by the polarizing beam splitter 7b when recording information on the disc 2b.

FIG. 9A shows the state when the beams 24d and 25d are focused at a focus point 22d in a position close to the substrate 21c in the recording layer 17b. When the focus point is at the position shown in FIG. 9A, the active diffraction lens 11c (FIG. 8) acts as a convex lens on the beam 24d. The beam 24d is incident on the objective lens 14c as somewhat strongly convergent light and linearly polarized light with a polarization direction parallel to the plane of the paper, and is focused midway toward the side of the recording layer 17b toward the reflective layer 20. In addition the active diffraction lens 11d acts as a concave lens on the beam 25d. The beam 25d is incident on the objective lens 14c as somewhat strongly divergent light and linearly polarized light with a polarization direction orthogonal to the plane of the paper. The beam 25d is transmitted by the recording layer 17b, is converted into circularly polarized light by passing through the quarter-wave plate layer 19, is reflected by the reflective layer 20, passes through the quarter-wave plate layer 19 and is converted into linearly polarized light with a polarization direction parallel to the plane of the paper, and is focused midway toward the side of the recording layer 17b opposite the reflective layer 20. The beam 24d and the beam 25d interfere at the focus point 22d and a minute diffraction grating is formed at the focus point 22d.

FIG. 9B shows the state when the beams 24e and 25e are focused at a focus point 22e in a position midway between the substrates 21c and 21d in the recording layer 17b. When the focus point is at the position shown in FIG. 9B, the active diffraction lens 11c does not act as a lens on the beam 24e. The beam 24e is incident on the objective lens 14c as medium-grade convergent light and linearly polarized light with a polarization direction parallel to the plane of the paper and is focused midway toward the side of the recording layer 17b toward the reflective layer 20. In addition, the active diffraction lens 11d does not act as a lens on the beam 25e. The beam 25e is incident on the objective lens 14c as medium-grade divergent light and linearly polarized light with a polarization direction orthogonal to the plane of the paper. The beam 25e is transmitted by the recording layer 17b, is converted into circularly polarized light by passing through the quarter-wave plate layer 19, is reflected by the reflective layer 20, is converted into linearly polarized light with a polarization direction parallel to the plane of the paper by passing through the quarter-wave plate layer 19, and is focused midway toward the side of the recording layer 17b opposite the reflective layer 20. The beam 24e and the beam 25e interfere at the focus point 22e and a minute diffraction grating is formed at the focus point 22e.

FIG. 9C shows the state when the beams 24f and 25f are focused at a focus point 22f in a position close to the substrate 21d in the recording layer 17b. When the focus point is at the position shown in FIG. 9C, the active diffraction lens 11c acts as a concave lens on the beam 24f. The beam 24f is incident on the objective lens 14c as somewhat weakly convergent light and linearly polarized light with a polarization direction parallel to the plane of the paper, and is focused midway toward the side of the recording layer 17b toward the reflective layer 20. In addition the active diffraction lens 11d acts as a convex lens on the beam 25f. The beam 25f is incident on the objective lens 14c as somewhat weakly divergent light and linearly polarized light with a polarization direction orthogonal to the plane of the paper. The beam 25f is transmitted by the recording layer 17b, is converted into circularly polarized light by passing through the quarter-wave plate layer 19, is reflected by the reflective layer 20, passes through the quarter-wave plate layer 19 and is converted into linearly polarized light with a polarization direction parallel to the plane of the paper, and is focused midway toward the side of the recording layer 17b opposite the reflective layer 20. The beam 24f and the beam 25f interfere at the focus point 22f and a minute diffraction grating is formed at the focus point 22f.

The beam 26b in FIGS. 9A to 9C is a focus control beam. The focus control beam 26b is controlled so as to be focused on the reflective layer 20 without dependence on the focus position of the recording/reproducing beam, as shown in FIGS. 9A to 9C. The focus control beam 26b emitted from the laser 3d when recording information on the disc is incident on the objective lens 14c as parallel light and is focused on the reflective layer 20. The beam 26b focused on the reflective layer 20 is reflected by the reflective layer 20, and is emitted from the objective lens 14c as parallel light. This reflected beam is ultimately received by the light detector 15d in FIG. 8.

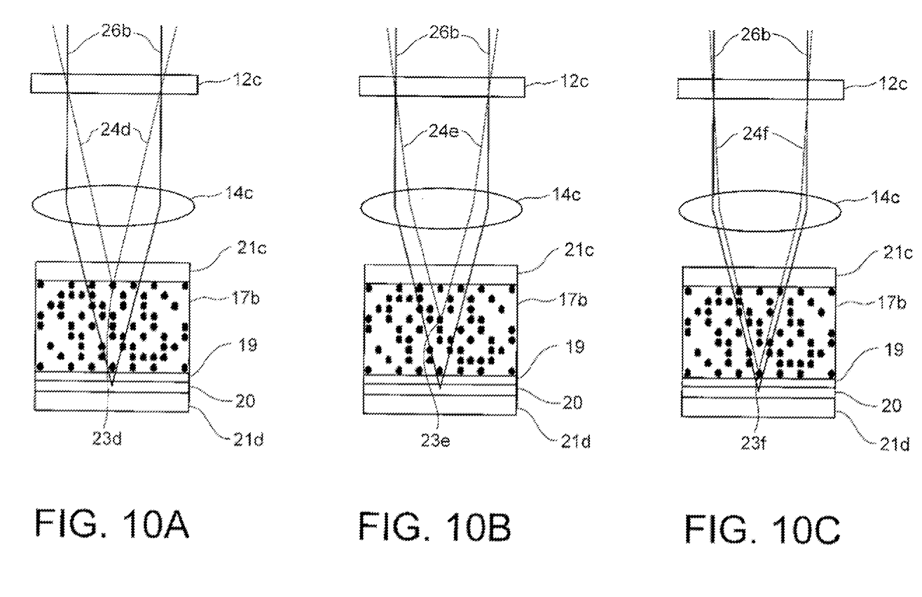

FIGS. 10A to 10C show the beams incident on the disc 2b and the beams reflected from the disc 2b when reproducing information from the disc 2b. Diffraction gratings having bit-data information are formed in the recording layer 17b of the disc 2b. The beams 24d to 24f illustrate beams selectively generated by the active diffraction lens 11c from beams emitted from the laser 3b and transmitted by the polarizing beam splitter 7b when reproducing information from the disc 2b.

FIG. 10A shows the state in which the beam 24d is focused on the diffraction grating 23d at a position in the recording layer 17b close to the substrate 21c. The diffraction grating 23d is formed at the position of the focus point 22d in FIG. 9A. When reading out information from the diffraction grating 23d, the active diffraction lens 11c acts as a convex lens on the beam 24d. The beam 24d is incident on the objective lens 14c as somewhat strongly convergent light and linearly polarized light with a polarization direction parallel to the plane of the paper, and is focused midway toward the side of the recording layer 17b towards the reflective layer 20. The beam 24d focused on the diffraction grating 23d is reflected by the diffraction grating 23d, and is emitted from the objective lens 14c as somewhat strongly divergent light and linearly polarized light with a polarization direction parallel to the plane of the paper. This reflected beam is ultimately received by the light detector 15b of FIG. 8.

FIG. 10B shows the state in which the beam 24e is focused on the diffraction grating 23d at a position in the recording layer 17b midway between the substrates 21c and 21d. The diffraction grating 23e is formed at the position of the focus point 22e in FIG. 9B. When reading out information from the diffraction grating 23e, the active diffraction lens 11c does not act as a lens on the beam 24e. The beam 24e is incident on the objective lens 14c as medium-grade convergent light and linearly polarized light with a polarization direction parallel to the plane of the paper, and is focused midway toward the side of the recording layer 17b towards the reflective layer 20. The beam 24e focused on the diffraction grating 23e is reflected by the diffraction grating 23e, and is emitted from the objective lens 14c as medium-grade divergent light and linearly polarized light with a polarization direction parallel to the plane of the paper. This reflected beam is ultimately received by the light detector 15b.

FIG. 10C shows the state in which the beam 24f is focused on the diffraction grating 23f at a position in the recording layer 17b close to the substrate 21d. The diffraction grating 23f is formed at the position of the focus point 22f in FIG. 9C. When reading out information from the diffraction grating 23f the active diffraction lens 11c acts as a concave lens on the beam 24f. The beam 24f is incident on the objective lens 14c as somewhat weakly convergent light and linearly polarized light with a polarization direction parallel to the plane of the paper, and is focused midway toward the side of the recording layer 17b towards the reflective layer 20. The beam 24f focused on the diffraction grating 23f is reflected by the diffraction grating 23f, and is emitted from the objective lens 14c as somewhat weakly divergent light and linearly polarized light with a polarization direction parallel to the plane of the paper. This reflected beam is ultimately received by the light detector 15b.

The beam 26b in FIGS. 10A to 10C is a focus control beam. The focus control beam 26b is controlled so as to be focused on the reflective layer 20 without dependence on the focus position of the recording/reproducing beam, as shown in FIGS. 9A to 9C. The focus control beam 26b emitted from the laser 3d when recording information on the disc is incident on the objective lens 14c as parallel light and is focused on the reflective layer 20. The beam 26b focused on the reflective layer 20 is reflected by the reflective layer 20, and is emitted from the objective lens 14c as parallel light. This reflected beam is ultimately received by the light detector 15d of FIG. 8.

The active diffraction lenses 11c and 11d selectively generate one of the multiple beams in accordance with the number of recording positions in a direction of a thickness in the recording layer 17b. If, for example, recording/reproducing information is possible at nine locations (nine layers) in a direction of a thickness of the recording layer 17b, the active diffraction lens 11c selectively generates one of the nine beams containing beams 24d to 24f. In addition, the active diffraction lens 11d selectively generates one out of the nine beams containing beams 25d to 25f. The active diffraction lenses 11c and 11d selectively generate one out of the nine beams, respectively, and discretely vary the distance between the focus point of the beam 26b and the focus point of the selectively generated beam in nine steps. Through this discrete variance in distance, the position of the focus point of the selectively generated beam can be varied discretely in nine steps in a direction of a thickness of the recording layer 17b. That is to say, using the selectively generated beam it is possible to record/reproduce information in nine layers in a direction of a thickness of the recording layer 17b.

The focus positions of the beams 24d to 24f that are recording/reproducing beams and the beam 26b that is the focus control beam are controlled by the variable focus lens 12c disposed along the common optical path. When the variable focus lens 12c is controlled and the focus position of the focus control beam 26b is varied, the focus position of the recording/reproducing beams 24d to 24f also varies accompanying that. At this time, the distance between the beams 24d to 24f and the beam 26b is determined in accordance with the beam selected by the active diffraction lens 11c. Consequently, even when the focus position of the focus control beam 26b is varied, the distance between the beams 24d to 24f and the beam 26b does not vary. Accordingly, using the variable focus lens 12c, the position of the focus point of the beam 26b is controlled so that the focus error signal becomes 0 and the beam 26b is focused on the reflective layer 20. Consequently, it is possible to accurately focus the beams 24d to 24f at a position separated from the reflective layer 20 by a distance in accordance with the beam selected by the active diffraction lens 11c.

The composition of the active diffraction lenses 11e and 11d is the same as that shown in FIG. 4. In addition, the relationship between the voltage impressed on the liquid crystal layers in the active diffraction lenses 11c and 11d and the focal length of the diffraction lenses is the same as that shown in FIG. 5. However, in the present embodiment, the polarization direction of the light does not rotate 90° between the outbound path and the inbound path of the recording/reproducing beam. Consequently, it is not necessary for the first diffraction lens and the second diffraction lens to respectively be a diffraction lens acting on first linearly polarized light whose polarization direction is a first direction, and a diffraction lens acting on second linearly polarized light whose polarization direction is a second direction orthogonal to the first direction.

When recording information on the disc 2b, the state of the active diffraction lens 11c when the beams 24d, 24e and 24f in FIGS. 9A to 9C are selectively generated corresponds to the states (i), (e) and (a), respectively, shown in FIG. 5. In addition, the state of the active diffraction lens 11d when the beams 25d, 25e and 25f in FIGS. 9A to 9C are selectively generated corresponds to the states (a), (e) and (i), respectively, shown in FIG. 5. When reproducing information from the disc 2b, the state of the active diffraction lens 11c when the beams 24d, 24e and 24f in FIGS. 10A to 10C are selectively generated corresponds to the states (i), (e) and (a), respectively, shown in FIG. 5.

Here, the focal length of the objective lens 14c is taken to be fₒ, and the position of the focal point of the beams 24e and 25e with the wavelength selection layer 20 as a reference is taken to be ΔF. In addition, Δf is the position of the focus point of the beam selectively generated by the active diffraction lenses 11c and 11d, with the wavelength selection layer 20 as reference. Here, Δf varies in 9 steps with a spacing of fₒ²/3F_{d}, from (−4fₒ²/3F_{d}+ΔF) to (+4fₒ²/3F_{d}+ΔF). For example, when F_{d}=300 mm, fₒ=3 mm and ΔF=−50 μm, Δf varies in 9 steps with a spacing of 10 μm from −90 μm to −10 μm. With the active diffraction lens, even if the voltages impressed on the first and second liquid crystal layers fluctuate somewhat, the diffraction efficiency of the first and second diffraction lenses alone fluctuates moderately and the focal length does not fluctuate, so Δf does not vary. Accordingly, the focus spot of the recording/reproducing beam can be accurately positioned at the layer where recording/reproducing should occur.

The active diffraction lens 11 shown in FIG. 4 is composed of a first and a second diffraction lens that selectively generate one out of a −1 order diffraction light, a 0 order diffraction light and a +1 order diffraction light from the incident light. By varying the focal length f_{d1} of the first diffraction lens in three steps between −F_{d}, ∞, +F_{d} and varying the focal length f_{d2} of the second diffraction lens in three steps between −3F_{d}, ∞, +3F_{d}, Δf is varied in nine steps with a spacing of fₒ²/3F_{d}, from (−4fₒ²/3F_{d}+ΔF) to (+4fₒ²/3F_{d}+ΔF). By using this kind of active diffraction lens 11, recording/reproducing information is possible in nine locations (nine layers) in the vertical direction of the recording layer 17b (FIGS. 9A to 9C, FIGS. 10A to 10C).

The composition of the active diffraction lenses 11c and 11d is not limited to the composition shown in FIG. 4, for other compositions are possible as well. For example, the active diffraction lens can be composed of first, second and third diffraction lenses that selectively generate one out of a −1 order diffraction light, a 0 order diffraction light and a +1 order diffraction light from the incident light. In this case, by varying the focal length of the first diffraction lens in three steps between −F_{d}, ∞, +F_{d}, varying the focal length of the second diffraction lens in three steps between −3F_{d}, ∞, +3F_{d}, and varying the focal length of the third diffraction lens in three steps between −9F_{d}, ∞, +9F_{d}, Δf is varied in 27 steps with a spacing of fₒ²/9F_{d}, from (−13fₒ²/9F_{d}+ΔF) to (+13fₒ²/9F_{d}+ΔF). By using an active diffraction lens with this kind of composition, recording/reproducing information is possible in 27 layers.

In addition, in place of the above description, the active diffraction lens can be composed of first and second diffraction lenses that selectively generate one out of five diffraction lights from the incident light, namely a −2 order diffraction light, a −1 order diffraction light, a 0 order diffraction light, a +1 order diffraction light and a +2 order diffraction light. In this case, by varying the focal length of the first diffraction lens in five steps between −F_{d}/2, −F_{d}, ∞, +F_{d} and +F_{d}/2 and varying the focal length of the second diffraction lens in five steps between −5F_{d}/2, −5F_{d}, ∞, +5F_{d} and +5F_{d}/2, Δf can be varied in 25 steps with a spacing of fₒ²/5F_{d}, from −12fₒ²/5F_{d}+ΔF to +12fₒ²/5F_{d}+ΔF. By using an active diffraction lens with this kind of composition, recording/reproducing information is possible in 25 layers.

Furthermore, the active diffraction lens may also have a composition using electro-optic crystals. For example, the active diffraction lens may be comprised using lithium niobate as the electro-optic crystal and in which a beam is incident in a direction parallel to the optical axis when a voltage is impressed in a direction parallel to the optical axis. In this active diffraction lens, one type of diffraction lens is used that acts on two types of beams with mutually orthogonal polarization directions. This diffraction lens acts as a concave lens on both of the two beams, does not act as a lens on either, or acts as a convex lens on both in accordance with the voltage impressed on the electro-optic crystal.

It is also possible for the active diffraction lens to be composed using two types of diffraction lenses that respectively act on two types of beams with mutually orthogonal polarization directions using liquid crystal layers in the active diffraction lens. In this case, although the speed of varying the focal length of the active diffraction lens is slow, it is possible to vary the focal length at low impressed voltages. In contrast, when an electro-optic crystal is used in the active diffraction lens, the impressed voltage for varying the focal length of the active diffraction lens is high but it is possible to vary the focal length at high speed.

The positions of the main planes of the active diffraction lenses 11c and 11d match the positions of the planes optically conjugate to the front side focal planes of the objective lens 14c. In other words, the main plane of the active diffraction lens 11c and the front side focal plane of the objective lens 14c are in optically conjugate positions with respect to the relay lens system composed of the convex lenses 4h and 4i. In addition, the main plane of the active diffraction lens 11d and the front side focal plane of the objective lens 14c are in optically conjugate positions with respect to the relay lens system composed of the convex lenses 4j and 4k. At this time, by opening apertures at the positions of the main planes of the active diffraction lenses 11c and 11d, the aperture number of the objective lens 14c does not vary even when the focal lengths of the active diffraction lenses 11c and 11d are varied.

Which out of the nine beams including the beams 24d to 24f and the nine beams including the beams 25d to 25f is selectively generated is switched by the active diffraction lenses 11c and 11d, respectively. Through this switching, the magnification of the objective lens 14c on the selectively generated beam varies, and the spherical aberration in the objective lens 14c varies. In addition, the optical path length to the focus point from the surface of the substrate 21c of the disc 2b for the selectively generated beam varies, and the spherical aberration in the disc 2b varies.

In the optical unit, the objective lens 14c is designed so that when the beam incident as parallel light on the objective lens 14c is focused on the reflective layer 20, the sum of the spherical aberration in the objective lens 14c and the spherical aberration in the disc 2b is 0. In addition, when the beam 24e incident as convergent light on the objective lens 14c is focused at the focus point 22e, the sum of the spherical aberration in the objective lens 14c, the spherical aberration in the disc 2b and the spherical aberration in the relay lens system composed of the convex lenses 4h and 4i is 0. In other words, the relay lens system composed of the convex lenses 4h and 4i is designed in this manner. Furthermore, when the beam 25e incident as divergent light on the objective lens 14c is focused at the focus point 22e, the sum of the spherical aberration in the objective lens 14c, the spherical aberration in the disc 2b and the spherical aberration in the relay lens system composed of the convex lenses 4j and 4k is 0. In other words, the relay lens system composed of the convex lenses 4j and 4k is designed in this manner.

When the lens power of the active diffraction lenses 11c and 11d is varied, the amount of variance in the magnification of the objective lens 14c is proportional to the lens power of the active diffraction lenses 11c and 11d. Consequently, the amount of variance in the spherical aberration in the objective lens 14c accompanying the variance in magnification of the objective lens 14c is proportional to the lens power of the active diffraction lenses 11c and 11d. In addition, the amount of variance in the optical path length from the surface of the substrate 21c in the disc 2b to the focus point is proportional to the lens power of the active diffraction lenses 11c and 11d. Consequently, the amount of variance in the spherical aberration in the disc 2b accompanying the variance in the optical path length from the surface of the substrate 21c in the disc 2b to the focus point is proportional to the lens power of the active diffraction lenses 11c and 11d.

The lens power of the active diffraction lenses 11c and 11d when the state of the active diffraction lenses 11c and 11d corresponds to the states in (a) through (i) of FIG. 5 is expressed by m×1/3 F_{d}. Here, the values of m in the states of (a) through (i) in FIG. 5 are −4 to +4, respectively. Accordingly, the amount of variance in the spherical aberration in the objective lens 14c accompanying the variance in the magnification of the objective lens 14c and the amount of variance in the spherical aberration in the disc 2b accompanying the variance in the optical path length from the surface of the substrate 21c in the disc 2b to the focus point can be respectively expressed by m×SAₒ and m×SAₘ.

When a spherical aberration is generated in the active diffraction lenses 11c and 11d, the generation amount of the spherical aberration in the active diffraction lenses 11c and 11d is proportional to the lens power of the active diffraction lenses 11c and 11d, respectively, and thus can be expressed by m×SA_{d}. At this time, the sum of the amount of variance in the spherical aberration in the objective lens 14c, the amount of variance in the spherical aberration in the disc 2b and the amount of variance in the spherical aberration in the active diffraction lenses 11c and 11d becomes m×(SAₒ+SAₘ+SA_{d}). That is to say, the generation amount of the spherical aberration in the active diffraction lenses 11c and 11d is determined so that SA_{d}=−(SAₒ+SAₘ). Through this spherical aberration, it is possible to eliminate the spherical aberrations generated in the objective lenses 14c and the disc 2b in accordance with variance in the lens power of the active diffraction lenses 11c and 11d using the spherical aberration generated in the active diffraction lenses 11c and 11d.

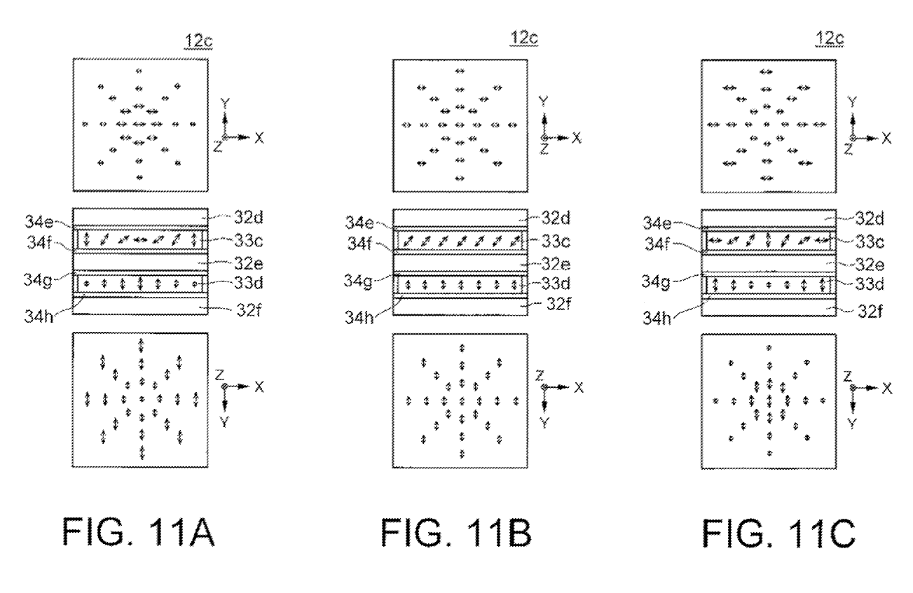

FIGS. 11A to 11C show the variable focus lens 12c. The variable focus lens 12c is composed of a liquid crystal layer 33c interposed between substrates 32d and 32e, and a liquid crystal layer 33d interposed between substrates 32e and 32f. On the surfaces of the substrates 32d and 32e on the side toward the liquid crystal layer 33c, transparent electrodes 34e and 34f, respectively, are formed for impressing alternating voltages on the liquid crystal layer 33c. In addition, on the surfaces of the substrates 32e and 32f on the side toward the liquid crystal layer 33d, transparent electrodes 34g and 34h, respectively, are formed for impressing alternating voltages on the liquid crystal layer 33d.

The transparent electrodes 34e and 34g are pattern electrodes and the transparent electrodes 34f and 34h are full-surface electrodes. The liquid crystal layer 33c and the transparent electrodes 34e and 34f comprise a first variable focus lens, and the liquid crystal layer 33d and the transparent electrodes 34g and 34h comprise a second variable focus lens. Glass, for example, may be used as the material of the substrates 32d to 32f. Nematic liquid crystal, for example, can be used as the material of the liquid crystal layers 33c and 33d. ITO, for example, can be used as the material of the transparent electrodes 34e to 34h.

The liquid crystal layers 33c and 33d have a single axis of refractive anisotropy. Calling n_{θ} and nₒ respectively the refractive indices of polarized light components in the direction parallel to and the direction orthogonal to the optical axis of the liquid crystal layers 33c and 33d, n_{θ}>nₒ establishes. The arrows shown in FIGS. 11A to 11C indicate the direction of the optical axis of the liquid crystal layers 33c and 33d. The optical axis of the liquid crystal layer 33c is in the X-Z plane, and the optical axis of the liquid crystal layer 33d is in the Y-Z plane. The first variable focus lens acts on linearly polarized light whose polarization direction is the X-axis direction, and does not act on linearly polarized light whose polarization direction is the Y-axis direction. On the other hand, the second variable focus lens acts on linearly polarized light whose polarization direction is the Y-axis direction, and does not act on linearly polarized light whose polarization direction is the X-axis direction. When recording information, the beam emitted from the laser 3b and transmitted by the polarizing beam splitter 7b, and the beam emitted from the laser 3b and reflected by the polarizing beam splitter 7b are incident on the liquid crystal layers 33c and 33d as linearly polarized light whose polarization direction is the X-axis direction and the Y-axis direction, respectively. In addition, when reproducing information from the disc 2b, the beam emitted from the laser 3b and transmitted by the polarizing beam splitter 7b and the beam reflected by the disc 2b and transmitted by the polarizing beam splitter 7b are incident on the liquid crystal layers 33c and 33d as linearly polarized light whose polarization direction is both the X-axis direction.

The transparent electrodes 34e and 34g are split into multiple electrodes of annular shape. Each electrode is connected by resistance to the neighboring electrode. In the variable focus lens 12c, mutually differing alternating voltages are impressed on the center and the perimeter of the liquid crystal layers 33e and 33g using the inside-most electrode and the outside-most electrode. By impressing alternating voltages in this manner, an alternating voltage distribution that is a second-order function is formed from the center toward the perimeter.

FIG. 11A illustrates the state when mutually differing alternating voltages are impressed on the center and the perimeter of the liquid crystal layers 33c and 33d. An alternating voltage with an effective value of (2.5−Δ) V is impressed on the center and an effective value of (2.5+Δ) V is impressed on the perimeter of the liquid crystal layer 33c, and an alternating voltage with an effective value of (2.5+Δ) V is impressed on the center and an effective value of (2.5−Δ) V is impressed on the perimeter of the liquid crystal layer 33d. In this state, the optical axis of the liquid crystal layer 33c is in a direction close to the X-axis direction at the center and is in a direction close to the Z-axis direction at the perimeter. In addition, the optical axis of the liquid crystal layer 33d is in a direction close to the Z-axis direction at the center and is in a direction close to the Y-axis direction at the perimeter. Accordingly, the refractive index of the liquid crystal layer 33c on linearly polarized light whose polarization direction is the X-axis direction is high at the center and low at the perimeter. In addition, the refractive index of the liquid crystal layer 33d on linearly polarized light whose polarization direction is the Y-axis direction is low at the center and high at the perimeter. As a result, the first variable focus lens acts as a convex lens on linearly polarized light whose polarization direction is the X-axis direction and the second variable focus lens acts as a concave lens on linearly polarized light whose polarization direction is the Y-axis direction. Here, the focal length of the first variable focus lens and the focal length of the second variable focus lens have equal absolute value but with the sign reversed. The larger Δ is, the smaller the absolute value of the focal length of the first and second variable focus lenses becomes.

FIG. 11B illustrates a separate state from FIG. 11A. An alternating voltage with an effective value of 2.5 V is impressed on the center and on the perimeter of the liquid crystal layer 33c, and an alternating voltage with an effective value of 2.5 V is impressed on the center and on the perimeter of the liquid crystal layer 33d. In this state, the optical axis of the liquid crystal layer 33c is in a direction midway between the X-axis direction and the Z-axis direction at both the center and the perimeter, and the optical axis of the liquid crystal layer 33d is in a direction midway between the Y-axis direction and the Z-axis direction at both the center and the perimeter. Accordingly, the refractive index of the liquid crystal layer 33c on linearly polarized light whose polarization direction is the X-axis direction is equal at the center and at the perimeter, and the refractive index of the liquid crystal layer 33d on linearly polarized light whose polarization direction is the Y-axis direction is equal at the center and at the perimeter. As a result, the first variable focus lens does not act as a lens on linearly polarized light whose polarization direction is the X-axis direction and the second variable focus lens does not act as a lens on linearly polarized light whose polarization direction is the Y-axis direction.

FIG. 11C illustrates a separate state from FIGS. 11A and 11B. An alternating voltage with an effective value of (2.5+Δ) V is impressed on the center and an effective value of (2.5−Δ) V is impressed on the perimeter of the liquid crystal layer 33c, and an alternating voltage with an effective value of (2.5−Δ) V is impressed on the center and an effective value of (2.5+Δ) V is impressed on the perimeter of the liquid crystal layer 33d. In this state, the optical axis of the liquid crystal layer 33c is in a direction close to the Z-axis direction at the center and is in a direction close to the X-axis direction at the perimeter. In addition, the optical axis of the liquid crystal layer 33d is in a direction close to the Y-axis direction at the center and is in a direction close to the Z-axis direction at the perimeter. Accordingly, the refractive index of the liquid crystal layer 33c on linearly polarized light whose polarization direction is the X-axis direction is low at the center and high at the perimeter. In addition, the refractive index of the liquid crystal layer 33d on linearly polarized light whose polarization direction is the Y-axis direction is high at the center and low at the perimeter. As a result, the first variable focus lens acts as a concave lens on linearly polarized light whose polarization direction is the X-axis direction and the second variable focus lens acts as a convex lens on linearly polarized light whose polarization direction is the Y-axis direction. Here, the focal length of the first variable focus lens and the focal length of the second variable focus lens have equal absolute values but with the sign reversed. The larger Δ is, the smaller the absolute value of the focal length of the first and second variable focus lenses becomes.

The variable focus lens 12c is controlled in accordance with the direction in which the focus points of the beam 24 (FIGS. 9A to 9C, FIGS. 10A to 10C), the beam 25 and the beam 26b are to be moved, when recording information on the disc 2b and when reproducing information from the disc 2b. For example, when the variable focus lens 12c is in the state shown in FIG. 11B, the variable focus lens 12c is caused to vary from the state in FIG. 11B to the state in FIG. 11A when moving the position of the focus point of the beam 24 and the beam 26b closer to the objective lens 14c. In this case, the first variable focus lens, which acts on the beam 24 and the beam 26b, works as a convex lens, and the focus position of the beam 24 and the beam 26b moves in the direction approaching the objective lens 14c. In addition, the second variable focus lens, which acts on the beam 25, works as a concave lens, and the focus position of the beam 26b focused after being reflected by the reflective layer 20 also moves toward the objective lens 14c side.

Conversely, the variable focus lens 12c is caused to vary from the state in FIG. 11B to the state in FIG. 11C when moving the position of the focus point of the beam 24 and the beam 26b in the direction away from the objective lens 14c. In this case, the first variable focus lens, which acts on the beam 24 and the beam 26b, works as a concave lens, and the focus position of the beam 24 and the beam 26b moves in the direction away from the objective lens 14c. In addition, the second variable focus lens, which acts on the beam 25, works as a convex lens, and the focus position of the beam 26b focused after being reflected by the reflective layer 20 also moves away from the objective lens 14c. By varying the focal length of the variable focus lens 12c, it is possible to move the recording/reproducing beams 24 and 25 and the focus control beam 26b the same distance in a direction of a thickness of the recording layer 17b.

The above description explained the composition using a liquid crystal layer in the variable focus lens 12c, but it is also possible to utilize a composition using an electro-optical crystal in the variable focus lens 12c. For example, the variable focus lens 12c is composed of one type of variable focus lens that acts on two types of beams with mutually orthogonal polarization directions when a voltage is impressed in a direction parallel to the optical axis and a beam is incident in a direction parallel to the optical axis, using lithium niobate as the electro-optical crystal. This variable focus lens acts as a convex lens on one of the two types of beams and acts as a concave lens on the other, or does not act as a lens on either, or acts as a concave lens on one and acts as a convex lens on the other, in accordance with the voltage impressed on the electro-optical crystal.

It is also possible to compose a variable focus lens 12c by two types of variable focus lens that respectively act on two types of beams having mutually orthogonal polarization directions, using a liquid crystal layer in the variable focus lens 12c. In this case, the speed of varying the focal length of the variable focus lens is slow, but it is possible to vary the focal length with low impressed voltages. In contrast, when an electro-optical crystal is used in the variable focus lens 12c, the impressed voltage when varying the focal length of the variable focus lens is high, but it is possible to vary the focal length at high speed.

The position of the main plane of the variable focus lens 12c matches the positions of the front side focal plane of the objective lens 14c and the position of the optically conjugate plane. At this time, by opening an aperture at the position of the main plane of the variable focus lens 12c, the aperture number of the objective lens 14c does not vary even when the focal length of the variable focus lens 12c is varied.

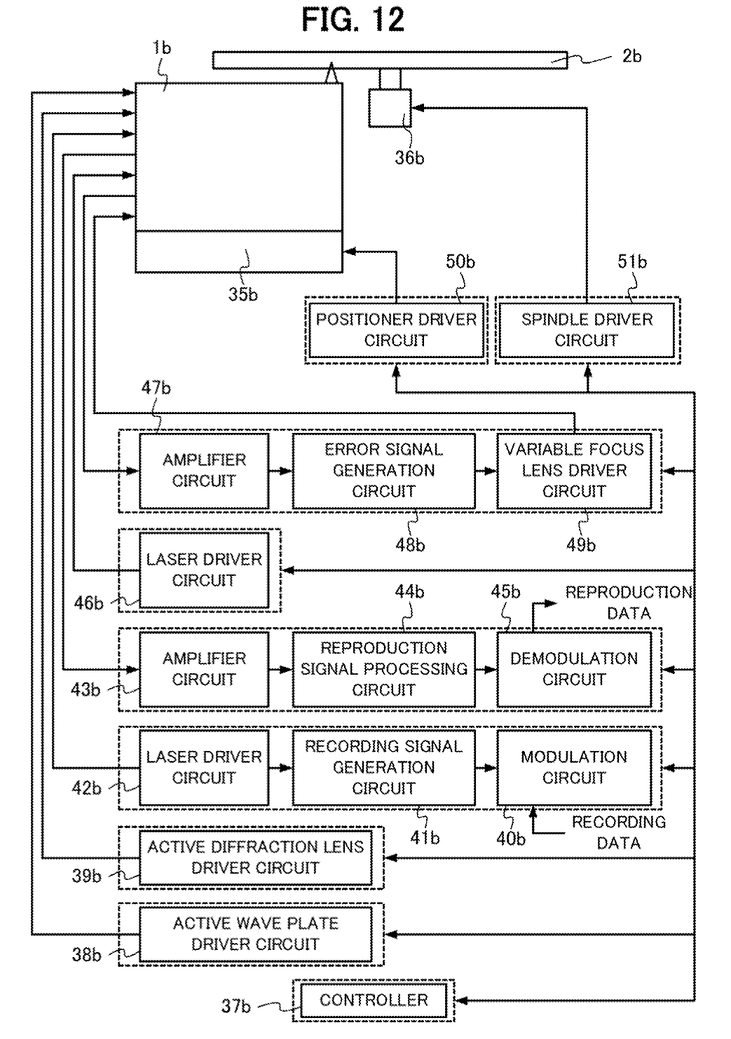

FIG. 12 shows an optical information recording/reproducing device that includes the optical unit shown in FIG. 8. The optical information recording/reproducing device has an optical unit 1b, a positioner 35b, a spindle 36b, a controller 37b, an active wave plate driver circuit 38b, an active diffraction lens driver circuit 39b, a modulation circuit 40b, a recording signal generation circuit 41b, a laser driver circuit 42b, an amplifier circuit 43b, a reproduction signal processing circuit 44b, a demodulation circuit 45b, a laser driver circuit 46b, an amplifier circuit 47b, an error signal generation circuit 48b, a variable focus lens driver circuit 49b, a positioner driver circuit 50b and a spindle driver circuit 51b.

The optical unit 1b has the composition shown in FIG. 8. The optical unit 1b is mounted on the positioner 35b. The disc 2b is an optical information recording medium for recording/reproducing and is mounted on the spindle 36b. The controller 37b controls the active wave plate driver circuit 38b, the active diffraction lens driver circuit 39b, the circuits from the modulation circuit 40b to the laser driver circuit 42b, the circuits from the amplifier circuit 43b to the demodulation circuit 45b, the laser driver circuit 46b, the circuits from the amplifier circuit 47b to the variable focus lens driver circuit 49b, the positioner driver circuit 50b and the spindle driver circuit 51b.

The active wave plate driver circuit 38b is a beam switching unit driver circuit. The active wave plate driver circuit 38b impresses an alternating voltage with an effective value of 2.5 V on the liquid crystal layer possessed by the active wave plate 5b so that the active wave plate 5b in the optical unit 1b functions as a quarter-wave plate, when recording information on the disc 2b. The active wave plate driver circuit 38b impresses an alternating voltage with an effective value of 5 V on the liquid crystal layer possessed by the active wave plate 5b so that the active wave plate 5b in the optical unit 1b functions as a full-wave plate, when reproducing information from the disc 2b.

The active diffraction lens driver circuit 39b is a first focus position varying circuit. The active diffraction lens driver circuit 39b impresses an alternating voltage with an effective value of either 0 V, 2.5 V or 5 V on the liquid crystal layers 28a to 28d (FIG. 4) the active diffraction lens 11c has so that the active diffraction lens 11c in the optical unit 1b selectively generates one out of the nine types of beams containing the beams 24d to 24f, when recording information to the disc 2b and when reproducing information from the disc 2b. In addition, the active diffraction lens driver circuit 39b impresses an alternating voltage with an effective value of 0 V, 2.5 V or 5 V on the liquid crystal layers 28a to 28d possessed by the active diffraction lens 11d so that the active diffraction lens 11d selectively generates one out of the nine types of beams containing the beams 25d to 25f, when recording information on the disc 2b.

The modulation circuit 40b modulates signals input from the outside as recording data in accordance with a modulation rule when recording information on the disc 2b. The recording signal generation circuit 41b generates a recording signal for driving the laser 3b in the optical unit 1b on the basis of the signal modulated by the modulation circuit 40b. The laser driver circuit 42b drives the laser 3b by supplying an electric current in accordance with the recording signal to the laser 3b on the basis of the recording signal generated by the recording signal generation circuit 41b when recording information on the disc 2b. In addition, the laser driver circuit 42b drives the laser 3b by supplying a constant electric current to the laser 3b so that the power of the light emitted from the laser 3b is a constant when reproducing information from the disc 2b.

The amplifier circuit 43b amplifies the voltage signal output from the light detector 15b in the optical unit 1b when reproducing information from the disc 2b. The reproduction signal processing circuit 44b generates, equalizes the waveform of and converts to binary values the reproduction signal recorded by the configuration of the diffraction grating on the disc 2b on the basis of the voltage signal amplified by the amplifier circuit 43b. The demodulation circuit 45b demodulates the signal converted to binary by the reproduction signal processing circuit 44b in accordance with a demodulation rule, and outputs this to the outside as reproduced data

The laser driver circuit 46b drives the laser 3d by supplying a constant electric current to the laser 3d so that the power of the light emitted from the laser 3d in the optical unit 1b is a constant when recording information on the disc 2b and when reproducing information from the disc 2b. The amplifier circuit 47b amplifies the voltage signal output from the light detector 15d in the optical unit 1b when recording information to the disc 2b and when reproducing information from the disc 2b. The error signal generation circuit 48b generates a focus error signal for driving the variable focus lens 12c in the optical unit 1b on the basis of the voltage signal amplified by the amplifier circuit 47b.

The variable focus lens driver circuit 49b is a second focus position varying circuit. The variable focus lens driver circuit 49b drives the variable focus lens 12c in the optical unit 1b. The variable focus lens driver circuit 49c impresses an alternating voltage on the liquid crystal layers 33c and 33d the variable focus lens 12c has, and drives the variable focus lens 12c. The variable focus lens driver circuit 49b controls the voltage impressed on the liquid crystal layer 33c possessed by the variable focus lens so that the focus error signal generated by the error signal generation circuit 49b becomes 0 and the beam 26b (FIGS. 9A to 9C, FIGS. 10A to 10C) is focused on the reflective layer 20.

The positioner driver circuit 50b causes the positioner 35b to move in the radial direction of the disc 2b and causes the positions of the focus points of the recording/reproducing beam and the focus control beam to move in the radial direction of the disc 2b when recording information on the disc 2b and when reproducing information from the disc 2b. The spindle driver circuit 51b supplies electric current to an unrepresented motor and causes the spindle 36b to rotate, thereby causing the positions of the focus points of the recording/reproducing beam and the focus control beam to move in the tangential direction of the disc 2b, when recording information on the disc 2b and when reproducing information from the disc 2b.

In the present embodiment, a first lens system (the active diffraction lens 11c) is provided that is capable of discretely varying, in a direction of a thickness of the recording layer, the position of focus point of the recording/reproducing beam focused in the recording layer of the disc 2b using the objective lens 14c, in the optical path of the recording/reproducing beam. In addition, a second optical system (the variable focus lens 12c) is provided that is capable of continuously varying, in a direction of a thickness of the disc 2b, the positions of the focus points of the recording/reproducing beam and the focus control beam that are focused using the objective lens 14c, in the optical path common to the recording/reproducing beam and the focus control beam.

The discrete variation amount of the position of the focus point of the recording/reproducing beam that is varied using the active diffraction lens 11c is determined by the properties of the active diffraction lens 11c. In addition, the distance between the position of the focus point of the focus control beam and the position of the focus point of the recording/reproducing beam is determined in accordance with the discrete variation amount of the focus position by the active diffraction lens 11c. Consequently, by accomplishing control so that the focus control beam is focused on the focus control reference surface of the disc 2b using the variable focus lens 12c, it is possible to make the position of the focus point of the recording/reproducing beam in a direction of a thickness of the recording layer accurately match the position where recording/reproducing should occur. Accordingly, with the present embodiment, recording of data in the correct position and reproducing data recording in the correct position are possible, and it is possible to ensure interchangeability of the disc between multiple optical units and optical information recording/reproducing devices.

The composition of the optical unit is not limited to that shown in FIG. 8. The optical unit may have parallel tracks formed in the tangential direction of the disc 2b on the reflective layer 20 (FIGS. 9A to 9C, FIGS. 10A to 10C) of the disc 2b, and a polarizing unit capable of varying the focus positions of the recording/reproducing beam and the focus control beam in the radial direction of the disc 2b may be provided in the optical unit 1b. This polarizing unit can use polarizing elements having liquid crystal layers. In addition, an optical information recording/reproducing device equipped with such an optical unit may have the following composition added to the composition shown in FIG. 12. That is to say, a second error signal generation circuit that generates track error signals for controlling the focus positions of the recording/reproducing beam and the focus control beam in the radial direction of the disc 2b, and a third focus position varying circuit that drives the polarizing unit on the basis of the track error signal, may be added to the composition of FIG. 12.

The second error signal generation circuit generates a track error signal for driving the polarizing elements in the optical unit 1b on the basis of the voltage signal that is the output of the light detector 15d amplified by the amplifier circuit 47b. The polarizing element driver circuit that is the third focus position varying circuit controls the polarizing element on the basis of the track error signal generated by the second error signal generation circuit and causes the focus positions of the recording/reproducing beam and the focus control beam to vary. The polarizing element driver circuit controls the alternating voltage impressed on the liquid crystal layers the polarizing element possesses, and controls the position of the focus point of the beam 26b in the radial direction of the disc 2b so that the track error signal becomes 0. By doing this, it is possible to focus the beam 26b on a track formed in the reflective layer 20.

In addition, it is possible to use a similar composition to the optical unit disclosed in Non-Patent Literature 1, that is to say a composition in which the optical unit 1b is equipped with a third light detector, a third lens system and a second polarizing unit. The third light detector receives the recording/reproducing beam reflected by the disc 2b when recording information on the disc 2b. The third lens system can vary, in a direction of a thickness of the recording layer 17b, the relative focus position of the beam that is emitted from the laser 3b and reflected by polarizing beam splitter 7b, with respect to the focus position of the beam that emitted from the laser 3b and transmitted by the polarizing beam splitter 7b. The second polarizing unit can vary the focus position of the beam reflected by the polarizing beam splitter 7b in both the radial direction and the tangential direction of the disc 2b. In the third lens system, it is possible to use the variable focus lens 12c. In the second polarizing unit, it is possible to use the second polarizing element having liquid crystal layers.

In addition, the optical information recording/reproducing device equipped with an optical unit having the above-described third light detector can have the following composition added to the composition shown in FIG. 12. That is to say, a third amplifier circuit for amplifying the output of the third light detector, a position deviation signal generation circuit that generates a position deviation signal, a fourth focus position varying circuit for driving the third lens system and a fifth focus position varying circuit for driving the second polarizing unit may be added to the composition of FIG. 12. The third amplifier circuit amplifies the voltage signal output from the third light detector in the optical unit 1b when recording information to the disc 2b. The position deviation signal generation circuit generates a position deviation signal for controlling the focus position of the beam reflected by the polarizing beam splitter 7b in a direction of a thickness of the recording layer 17b and the radial direction and the tangential direction of the disc 2b, relative to the focus position of the beam emitted from the laser 3b and transmitted by the polarizing beam splitter 7b. Here, the position deviation signal generation circuit generates the position deviation signal on the basis of the output from the third light detector amplified by the third amplifier circuit.

The fourth focus position varying circuit is a second variable focus lens driver circuit for driving the variable focus lens 12c. The second variable focus lens driver circuit impresses an alternating voltage on the liquid crystal layer 33d (FIGS. 11A to 11C) the variable focus lens 12c possesses. By impressing this alternating voltage, the relative focus position of the beam reflected by the polarizing beam splitter 7b is controlled in a direction of a thickness of the recording layer 17b relative to the focus position of the beam emitted from the laser 3b and transmitted by the polarizing beam splitter 7b. The second variable focus lens driver circuit drives the variable focus lens 12c so that the position deviation signal becomes 0. That is to say, the second variable focus lens driver circuit drives the variable focus lens 12c so that the focus position of the beam emitted from the laser 3b and transmitted by the polarizing beam splitter 7b and the focus position of the beam emitted from the laser 3b and reflected by the polarizing beam splitter 7b match in a direction of a thickness of the recording layer 17b.

The fifth focus position varying circuit is the second polarizing element driver circuit for driving the second polarizing element. The second polarizing element driver circuit impresses an alternating voltage on the liquid crystal layers the second polarizing element possesses. By impressing this alternating voltage, the relative focus position of the beam emitted from the laser 3b and reflected by the polarizing beam splitter 7b is controlled in the radial direction and the tangential direction of the disc 2b relative to the focus position of the beam emitted from the laser 3b and transmitted by the polarizing beam splitter 7b. The second polarizing element driver circuit drives the second polarizing element so that the position deviation signal generated by the position deviation signal generation circuit becomes 0. That is to say, the second polarizing element driver circuit drives the second polarizing element so that the focus position of the beam emitted from the laser 3b and transmitted by the polarizing beam splitter 7b and the focus position of the beam reflected by the polarizing beam splitter 7b match in the radial direction and the tangential direction of the disc 2b. Consequently, the beam emitted from the laser 3b and transmitted by the polarizing beam splitter 7b and the beam emitted from the laser 3b and reflected by the polarizing beam splitter 7b can be focused in the same position in the recording layer.

In the above embodiments, the optical unit was explained as an optical unit for bit-type hologram recording, and the optical information recording/reproducing device was explained as an optical information recording/reproducing device for bit-type hologram recording. However, the optical unit and the optical information recording/reproducing device according to the present invention are not limited to bit-type hologram recording and can be applied to other recording that accomplishes three-dimensional information recording/reproducing on an optical recording medium. For example, the present invention can be applied to page-type hologram recording, two-photon absorption recording and the like.

In the above embodiments, an example using a variable focus lens in the second lens system was explained, but the second lens system is not limited to a variable focus lens and need only be capable of continuously varying the focus positions of the recording/reproducing beam and the focus control beam in a direction of a thickness of the recording layer. For example, in the optical unit 1a shown in FIG. 1, the focus positions of the recording/reproducing beam corresponding to the beam 24 and the focus control beam corresponding to the beam 26a in FIGS. 2A to 2C and FIGS. 3A to 3C may be continuously varied in a direction of a thickness of the recording layer by driving the objective lens 14a positioned in the optical path common to the recording/reproducing beam and the focus control beam. Here, the focus position of the recording/reproducing beam 25 that is focused at the same position as the beam 24 can be controlled in a direction of a thickness of the recording layer by driving the objective lens 14b.

In addition, with the optical unit 1b shown in FIG. 8, for example, it is possible to use relay system lenses positioned in the optical path common to the recording/reproducing beam and the focus control beam as the second lens system. In this case, it is possible to continuously vary the focus positions of the recording/reproducing beam corresponding to beam 24 and the focus control beam corresponding to the beam 26b in FIGS. 9A to 9C and FIGS. 10A to 10C in a direction of a thickness of the recording layer by displacing at least one of the convex lenses 4h and 4i that comprise the relay system lenses. The focus positions of the recording/reproducing beam 25 focused at the same position as the beam 24 can be controlled in a direction of a thickness of the recording layer by displacing at least one of the convex lenses 4j and 4k that comprise the relay system lenses.

The present invention was specially illustrated and explained with reference to exemplary embodiments, but the present invention can achieve the objectives of the present invention even with the following minimal composition.

The optical unit according to a first configuration of the present invention in a minimal composition thereof has an optical system that shines a laser light on an optical recording medium having a recording layer and a focus control reference surface, and this optical system has an objective lens that focuses a recording/reproducing beam emitted from a first light source onto the recording layer and focuses a focus control beam emitted from a second light source onto the focus control reference surface, a first lens system disposed along an optical path of the recording/reproducing beam for discretely varying a focus position of the recording/reproducing beam in a direction of a thickness of the recording layer, and a second lens system disposed along an optical path common to the recording/reproducing beam and the focus control beam for continuously varying focus positions of the recording/reproducing beam and the focus control beam in a direction of a thickness of the recording layer.

The optical information recording/reproducing device according to a second configuration of the present invention in a minimal composition thereof has the above-described optical unit of the present invention, a first focus position varying circuit for driving the first lens system and varying a focus position of the recording/reproducing beam, an error signal generation circuit for generating a focus error signal for controlling focus positions of the recording/reproducing beam and the focus control beam in a direction of a thickness of the recording layer on the basis of an output from a light detector that receives a light of the focus control beam reflected from the optical recording medium, and a second focus position varying circuit for driving the second lens system on the basis of the focus error signal and varying focus positions of the recording/reproducing beam and the focus control beam.

In addition, the optical information recording/reproducing device according to a third configuration of the present invention in a minimal composition thereof has the above-described optical unit of the present invention, a first focus position varying circuit for driving the first lens system and varying a focus position of the recording/reproducing beam, an error signal generation circuit for generating a focus error signal for controlling focus positions of the recording/reproducing beam and the focus control beam in a direction of a thickness of the recording layer on the basis of an output from a light detector that receives a light of the focus control beam reflected from the optical recording medium, a second focus position varying circuit for driving the second lens system on the basis of the focus error signal and varying focus positions of the recording/reproducing beam and the focus control beam, and a beam switching unit driver circuit for driving the beam switching unit and making the recording/reproducing beam the two beams when recording information on the optical recording medium, and making the recording/reproducing beam the single beam when reproducing information from the optical recording medium.

In addition, the optical unit control method according to a fourth configuration of the present invention in a minimal composition thereof is an optical unit control method that shines laser light on an optical recording medium having a recording layer and a focus control reference surface, and provides a control method for shining a recording/reproducing beam from a first light source onto an optical recording medium, shining a focus control beam from a second light source onto an optical recording medium, continuously controlling a focus position of the focus control beam in a direction of a thickness of the recording layer, focusing the focus control beam on the focus control reference surface, and discretely varying a focus position of the recording/reproducing beam in a direction of a thickness of the recording layer.

With the above-described minimal compositions of the optical unit, the control method thereof and the optical information recording/reproducing device, the efficacy of being able to correctly position the focus spot of the recording/reproducing beam in the layer where recording/reproducing should occur can be obtained.

In addition, as noted above the present invention was explained with reference to exemplary embodiments, but this is intended to be illustrative and not limiting, and it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

This application claims the benefit of Japanese Patent Application 2008-193385, filed on Jul. 28, 2008, the entire disclosure of which is incorporated by reference herein.

1. An optical unit including an optical system for shining a laser light on an optical recording medium having a recording layer and a focus control reference surface, said optical system comprising:
an objective lens for focusing a recording/reproducing beam emitted from a first light source in the recording layer and focusing a focus control beam emitted from a second light source on the focus control reference surface;
a first lens system disposed along an optical path of the recording/reproducing beam and capable of discretely varying a focus position of the recording/reproducing beam in a direction of a thickness of the recording layer; and
a second lens system disposed along an optical path common to the recording/reproducing beam and the focus control beam and capable of continuously varying focus positions of the recording/reproducing beam and the focus control beam in a direction of a thickness of the recording layer.

2. The optical unit according to claim 1, wherein the first lens system includes at least one diffraction lens whose focal length can be discretely varied in accordance with an impressed voltage.

3. The optical unit according to claim 2, wherein the at least one diffraction lens includes multiple diffraction lenses whose focal lengths can be discretely varied, wherein amounts of variances in the focal lengths mutually differ.

4. The optical unit according to claim 3, wherein each of the multiple diffraction lenses includes a diffraction lens that acts on first linearly polarized light whose polarization direction is a first direction, and a diffraction lens that acts on second linearly polarized light whose polarization direction is a second direction orthogonal to the first direction.

5. The optical unit according to claim 2, wherein a position of a main plane of the at least one diffraction lens coincides with a position of a front side focal plane of the objective lens or a position of a plane optically conjugate to a front side focal plane of the objective lens.

6. The optical unit according to claim 2, wherein the at least one diffraction lens provides a spherical aberration that eliminates spherical aberrations generated by the objective lens and the optical recording medium for the recording/reproducing beam.

7. The optical unit according to claim 1, wherein the second lens system includes at least one variable focus lens whose focal length can be continuously varied in accordance with an impressed voltage.

8. The optical unit according to claim 7, wherein the at least one variable focus lens has a first variable focus lens that acts on first linearly polarized light whose polarization direction is a first direction, and a second variable focus lens that acts on second linearly polarized light whose polarization direction is a second direction orthogonal to the first direction.

9. The optical unit according to claim 7, wherein a position of a main plane of the at least one variable focus lens coincides with a position of a front side focal plane of the objective lens or a position of a plane optically conjugate to a front side focal plane of the objective lens.

10. The optical unit according to claim 1, further comprising a beam switching unit capable of switching the recording/reproducing beam between a single beam and two beams focused on the same position in mutually opposite directions in the recording layer.

11. An optical information recording/reproducing device comprising:
the optical unit according to claim 1;
a first focus position varying circuit for driving the first lens system and varying a focus position of the recording/reproducing beam;
an error signal generating circuit for generating a focus error signal for controlling focus positions of the recording/reproducing beam and the focus control beam in a direction of a thickness of the recording layer on the basis of an output from a light detector that receives a light of the focus control beam reflected from the optical recording medium; and
a second focus position varying circuit for driving the second lens system on the basis of the focus error signal and varying focus positions of the recording/reproducing beam and the focus control beam.

12. An optical information recording/reproducing device comprising:
the optical unit according to claim 10;
a first focus position varying circuit for driving the first lens system and varying a focus position of the recording/reproducing beam;
an error signal generating circuit for generating a focus error signal for controlling focus positions of the recording/reproducing beam and the focus control beam in a direction of a thickness of the recording layer on the basis of an output from a light detector that receives a light of the focus control beam reflected from the optical recording medium;
a second focus position varying circuit for driving the second lens system on the basis of the focus error signal and varying focus positions of the recording/reproducing beam and the focus control beam; and
a beam switching unit driver circuit for driving the beam switching unit and making the recording/reproducing beam the two beams when recording information on the optical recording medium and making the recording/reproducing beam the single beam when reproducing information from the optical recording medium.

13. An optical unit control method, being an optical unit control is method for shining a laser light on an optical recording medium having a recording layer and a focus control reference surface, said method:
shining a recording/reproducing beam from a first light source on an optical recording medium;
shining a focus control beam from a second light source on an optical recording medium;
continuously controlling a focus position of the focus control beam in a direction of a thickness of the recording layer and focusing the focus control beam on the focus control reference surface; and
discretely varying a focus position of the recording/reproducing beam in a direction of a thickness of the recording layer.
